(19) United States
(12) Patent Application Publication
(10) Pub. No.: US 2006/0262149 A1
(43) Pub. Date: Nov. 23, 2006

(54) Ink jet ink and recording material

(76) Inventors: Mervin G. Wood, Maysville, KY (US); Joseph Suhadolnik, Yorktown Heights, NY (US); Robert E. Detlefsen, Putnam Valley, NY (US); Walter Renz, Brookfield, CT (US)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/431,974

(22) Filed: May 11, 2006

Related U.S. Application Data
(60) Provisional application No. 60/682,232, filed on May 18, 2005.

(51) Int. Cl. B41J 2/01

(52) U.S. Cl. 347/1

(57) ABSTRACT

The present invention relates to an ink-jet ink, an ink-jet recording material or an ink-jet system containing at least one water-soluble hindered amine compound of the general formula (I): 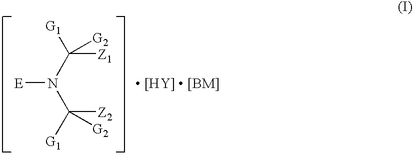
wherein G₁ and G₂ are independently alkyl of 1 to 4 carbon atoms or are together pentamethylene; Z₁ and Z₂ are each methyl, or Z₁ and Z₂ together form an unsubstituted linking moiety or a linking moiety substituted by one or more groups selected from an ester, ether, hydroxy, oxo, cyanohydrin, amide, amino, carboxy or an urethane group; E is alkoxy of 1 to 18 carbon atoms, cycloalkoxy of 5 to 12 carbon atoms or aralkoxy of 7 to 15 carbon atoms, or E is —O-T-(OH)_{b}; T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms; b is 1, 2 or 3 with the proviso that b cannot exceed the number of carbon atoms in T, and when b is 2 or 3, each hydroxyl group is attached to a different carbon atoms of T; BM is a basic material selected from the group consisting of alkali metal hydroxides, alkaline earth metal hydroxides, and amines; and, HY is an inorganic or organic acid; and, wherein the total charge of cations is equal to the total charge of anions.

This application claims benefit under 35 USC 119(e) of U.S. provisional app. No. 60/682,232, filed May 18, 2005.

The present invention relates to an ink jet ink, an ink jet recording material or an ink-jet system with improved properties.

In the ink-jet process, an image is produced by ejecting ink droplets onto a recording material through a nozzle. The ink is in most cases an aqueous solution of a dye. The recording material should rapidly and permanently fix the said dye. Specially prepared papers or plastic films provided with a dye-binding layer are mostly used for this purpose. Owing to the fineness of the nozzles, dyes which are completely dissolved in the ink vehicle are preferred to pigments. Besides, dyes offer a higher chroma and a better color gamut when compared to pigments. However, ink-jet dyes usually have a poorer fastness to light than, for example, the colored pigments customary in conventional printing inks. As a result, images produced by ink-jet printing usually have a limited lifetime when subjected to light and thus rapidly begin to fade or discolor.

Various classes of substances are known for this purpose, e.g. water soluble dialkoxybenzenes (EP-A-373 573), water-insoluble phenols, bisphenols, hydroquinones and hydroquinone diethers (GB 2 088 777), and water soluble phenols and bisphenols (U.S. Pat. No. 5,509,957 and U.S. Pat. No. 5,089,050). The use of certain hindered amine compounds in ink-jet ink or media is reported in e.g. JP-A-2000062310, JP-A-05239389, JP-A-61146591, WO 02/055618 and JP-A-11348418. The use of specific water-soluble or water-dispersible N-heterocyclic or aliphatic amine compounds in ink-jet inks or media is disclosed in EP-A-882 600 and JP-A-2000044851.

EP-A-1 036 666 discloses the use of certain N-alkoxy substituted hindered amines in ink jet recording materials.

U.S. Pat. No. 6,447,644 discloses the use of certain hindered amines and salts therefrom for the stabilization of wood pulp and paper the relevant parts of which are incorporated herein by reference.

Pending application U.S. Ser. No. 11/086,644, filed Mar. 22, 2005, discloses the use of certain hindered amine salts for the stabilization of ink jet inks and ink jet recording systems.

It is now found that certain water-soluble hindered amines provide outstanding protection against light-induced fading of ink-jet prints.

The present invention therefore relates to an ink-jet system, ink-jet recording material, or ink-jet ink containing at least one water-soluble hindered amine compound of the formula (I) 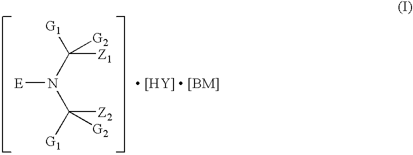
wherein
G₁ and G₂ are independently alkyl of 1 to 4 carbon atoms or are together pentamethylene; Z₁ and Z₂ are each methyl, or Z₁ and Z₂ together form an unsubstituted linking moiety or a linking moiety substituted by one or more groups selected from an ester, ether, hydroxy, oxo, cyanohydrin, amide, amino, carboxy or an urethane group;
E is alkoxy of 1 to 18 carbon atoms, cycloalkoxy of 5 to 12 carbon atoms or aralkoxy of 7 to 15 carbon atoms, or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
HY is an inorganic or organic acid; and, wherein the total charge of cations is equal to the total charge of anions; and
BM is a basic material selected from the group consisting of alkali metal hydroxides, alkaline earth metal hydroxides, and amines.

Y is phosphate, phosphonate, carbonate, bicarbonate, nitrate, chloride, bromide, bisulfite, sulfite, bisulfate, sulfate, borate, formate, acetate, benzoate, citrate, oxalate, tartrate, acrylate, polyacrylate, fumarate, maleate, itaconate, glycolate, gluconate, malate, mandelate, tiglate, ascorbate, polymethacrylate, a carboxylate of nitrilotriacetic acid, a carboxlylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

Y is a carboxylate, especially a carboxylate of a mono-, di-, tri- or tetracarboxylic acid, mainly of 1-18 carbon atoms, such as a formate, acetate, benzoate, citrate, or oxalate.

For example, Y is chloride, bisulfate, sulfate, phosphate, nitrate, ascorbate, formate, acetate, benzoate, oxalate, citrate, a carboxylate of ethylenediaminetetraacetic acid or of diethylenetriaminepentaacetic acid or polyacrylate.

For instance, Y is chloride, bisulfate, ascorbate, or citrate.

Amines are defined as R₁₁₅—N(R₁₁₆)—R₁₁₇, wherein

R₁₁₅, R₁₁₆, and R₁₁₇ are independently hydrogen, straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or said alkyl substituted by one or more —OH, —OCO—R₁₁₈, —OR₁₁₉, or —NH₂— groups or mixtures thereof; or said alkyl or said alkenyl interrupted by one or more —O—, —NH— or —NR₁₁₉— groups or mixtures thereof and which can be unsubstituted or substituted by one or more —OH, —OR₁₁₉ or —NH₂ groups or mixtures thereof;

R₁₁₈ is hydrogen, straight or branched chain C₁-C₁₈alkyl, C₅-C₁₂cycloalkyl, straight or branched chain C₃-C₈alkenyl, C₆-C₁₄aryl or C₇-C₁₅aralkyl,

R₁₁₉ is straight or branched chain alkyl of 1 to 18 carbon atoms.

The total charge for the salts of formula (I) is neutral. For example, the total number of cations is equal to the total number of anions.

Alkali metal hydroxide is sodium hydroxide, potassium hydroxide, or rubidium hydroxide.

For instance, the alkali metal hydroxide is sodium hydroxide or potassium hydroxide.

Alkaline earth metal hydroxide is magnesium hydroxide, calcium hydroxide, strontium hydroxide, or barium hydroxide.

For instance, the alkaline earth metal hydroxide is magnesium hydroxide or calcium hydroxide.

The water-soluble hindered amine compounds described herein are salts of the corresponding hindered amine compounds.

For example, Z₁ and Z₂ together are a hydrocarbon linking moiety containing 1-200 carbon and heteroatoms; for instance, 1-60 carbon atoms and 0-60 heteroatoms; especially, 0-30 heteroatoms selected from oxygen atoms and nitrogen atoms.

For instance, Z₁ and Z₂ as a linking moiety are a chain of 2 or 3 carbon atoms or 1 or 2 carbon atoms and a nitrogen or oxygen atom forming together with the remaining structure in formula (I) a saturated unsubstituted 5- or 6-membered heterocyclic ring or a 5- or 6-membered heterocyclic ring substituted by one or more groups selected from an ester, ether, hydroxy, oxo, cyanohydrin, amide, amino, carboxy or an urethane group. The substituents in Z1 and Z2 themselves may contain hindered amine moieties. For example, the compounds of the formula (I) contain 1-4 hindered amine or hindered ammonium groups. For instance, the compounds of formula (I) contain 1 or 2 hindered amine or hindered ammonium moieties.

Any group denoted as aryl mainly means C₆-C₁₂aryl; for example, aryl is phenyl or naphthyl; for instance, aryl is phenyl.

Group denoted as alkyl are, within the definitions given, mainly C₁-C₁₈alkyl, for example methyl, ethyl, propyl such as n- or isopropyl, butyl such as n-, iso-, sec- and tert-butyl, pentyl, hexyl, heptyl, octyl, nonyl, decyl, undecyl, dodecyl, tridecyl, tetradecyl, pentadecyl, hexadecyl, heptadecyl, or octadecyl.

Groups denoted as alkylene are, within the definitions given, for example methylene, 1,2-ethylene, 1,1-ethylene, 1,3-propylene, 1,2-propylene, 1,1-propylene, 2,2-propylene, 1,4-butylene, 1,3-butylene, 1,2-butylene, 1,1-butylene, 2,2-butylene, 2,3-butylene, or —C₅H₁₀—, —C₆H₁₂—, C₇H₁₄, —C₈H₁₆—, —C₉H₁₈—, —C₁₀H₂₀—, —C₁₁H₂₂—, —C₁₂H₂₄—, —C₁₃H₂₆—, —C₁₄H₂₈—, —C₁₅H₃₀—, —C₁₆H₃₂—, —C₁₇H₃₄—, or —C₁₈H₃₆—.

Groups denoted as cycloalkyl or cycloalkoxy are mainly C₅-C₁₂cycloalkyl or C₅-C₁₂cycloalkoxy, the cycloalkyl part being, for example, cyclopentyl, cyclohexyl, cycloheptyl, cyclooctyl, cyclononyl, cyclodecyl, cycloundecyl, or cyclododecyl. Cycloalkenyl is mainly C₅-C₁₂cycloalkenyl including cyclopentenyl, cyclohexenyl, cycloheptenyl, cyclooctenyl, cyclononenyl, cyclodecenyl, cycloundecenyl, or cyclododecenyl.

Aralkyl or aralkoxy is, for example, phenylalkyl or phenylalkoxy, which is alkyl or alkoxy substituted by phenyl. Examples for phenylalkyl or phenylalkoxy are, within the definitions given, benzyl, benzyloxy, alpha-methylbenzyl, alpha-methylbenzyloxy, cumyl, or cumyloxy.

Alkenyl residues are mainly alkenyl of 2 to 18 carbon atoms; for example, allyl.

Alkynyl residues are mainly alkynyl of 2 to 12 carbon atoms; for example, propargyl.

A group denoted as acyl is mainly R(C═O)—, where R is an aliphatic or aromatic moiety.

An aliphatic or aromatic moiety, such as mentioned above or other definitions, mainly is an aliphatic or aromatic C₁-C₃₀hydrocarbon; examples are aryl, alkyl, cycloalkyl, alkenyl, cycloalkenyl, bicycloalkyl, bicycloalkenyl, and combinations of these groups.

Examples for acyl groups are alkanoyl of 2 to 12 carbon atoms, alkenoyl of 3 to 12 carbon atoms, or benzoyl.

Alkanoyl embraces, for example, formyl, acetyl, propionyl, butyryl, pentanoyl, oroctanoyl; for example, C₂-C₈alkanoyl; for instance, acetyl.

Alkenoyl residues are, for example, acryloyl, or methacryloyl.

The alkyl groups in the different substituents may be linear or branched.

Examples for alkenyl groups with 2 to 4 carbon atoms are ethenyl, propenyl, or butenyl.

Examples for alkyl groups with 1 to 4 carbon atoms interrupted by one or two oxygen atoms are —CH₂—O—CH₃, —CH₂—CH₂—O—CH₃, —CH₂—CH₂—O—CH₂—CH₃, —CH₂—O—CH₂—CH₂—O—CH₃, or —CH₂—O—CH₂—O—CH₃.

Examples for hydroxy substituted alkyl groups with 2 to 6 carbon atoms are hydroxy ethyl, di-hydroxy ethyl, hydroxy propyl, di-hydroxy propyl, hydroxy butyl, hydroxy pentyl, or hydroxy hexyl.

The solubility of the compounds of formula (I) in water at 20° C. and standard pressure is, for example, at least about 1 g/l; for instance, at least about 10 g/l.

The invention also relates to an ink-jet recording material containing at least one water-soluble hindered amine of the formula (I) as defined above.

The invention also relates to an ink-jet ink containing at least one water soluble hindered amine of the formula (I) as defined above.

Furthermore, the invention relates to an ink-jet system, comprising a recording material and at least one colored ink to be applied to the recording material by means of an ink-jet nozzle, characterized in that at least either the recording material or at least one colored ink contains at least one water soluble hindered amine of the formula (I) as defined above.

Furthermore, the invention relates to a method for stabilizing ink-jet prints which comprises applying to a recording material for ink-jet printing an ink composition containing a water soluble dye or a solution of a dye in an organic solvent and at least one compound of the formula (I) as defined above and drying said recording material.

In another embodiment, the method for stabilizing ink-jet prints comprises applying to a recording material for ink-jet printing a casting or coating dispersion or an aqueous or organic solution containing at least one compound of the formula (I) as defined above and further applying either an ink composition containing a water soluble dye or a solution of a dye in an organic solvent; or an ink composition containing a water soluble dye or a solution of a dye in an organic solvent and at least one compound of the formula (I) and drying said recording material.

Another embodiment of the instant invention is a water-soluble hindered amine compound of the formula (I) 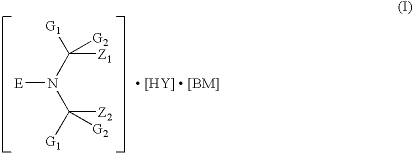
wherein
G₁ and G₂ are independently alkyl of 1 to 4 carbon atoms or are together pentamethylene; Z₁ and Z₂ are each methyl, or Z₁ and Z₂ together form an unsubstituted linking moiety or a linking moiety substituted by one or more groups selected from an ester, ether, hydroxy, oxo, cyanohydrin, amide, amino, carboxy or an urethane group;
E is alkoxy of 1 to 18 carbon atoms, cycloalkoxy of 5 to 12 carbon atoms or aralkoxy of 7 to 15 carbon atoms, or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
HY is an inorganic or organic acid; and, wherein the total charge of cations is equal to the total charge of anions; and
BM is a basic material selected from the group consisting of alkali metal hydroxides, alkaline earth metal hydroxides, and amines.
Y is phosphate, phosphonate, carbonate, bicarbonate, nitrate, chloride, bromide, bisulfite, sulfite, bisulfate, sulfate, borate, formate, acetate, benzoate, citrate, oxalate, tartrate, acrylate, polyacrylate, fumarate, maleate, itaconate, glycolate, gluconate, malate, mandelate, tiglate, ascorbate, polymethacrylate, a carboxylate of nitrilotriacetic acid, a carboxlylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

Examples of especially suited compounds of formula (I) are selected from the group consisting of formulae A* to EE* and (III) to (IIIc): 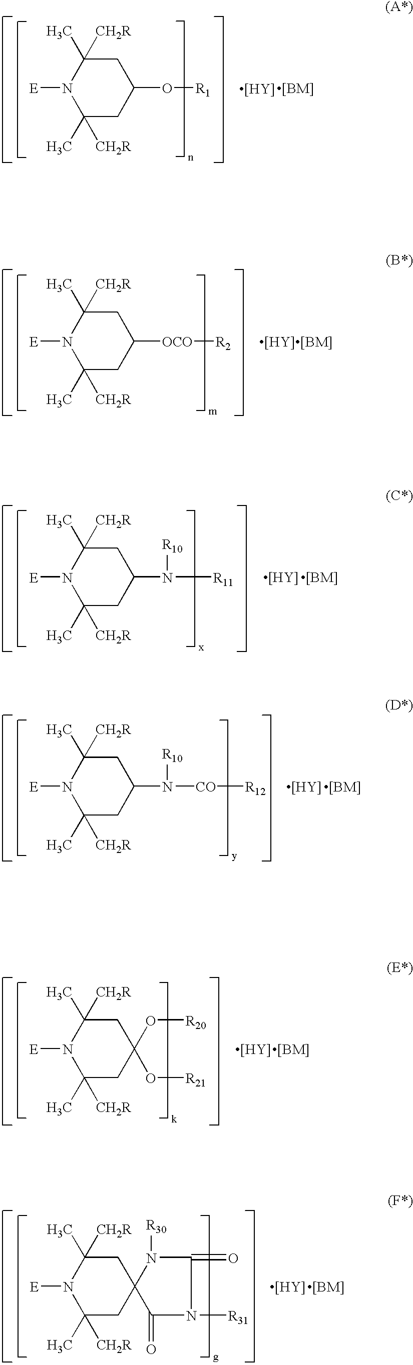 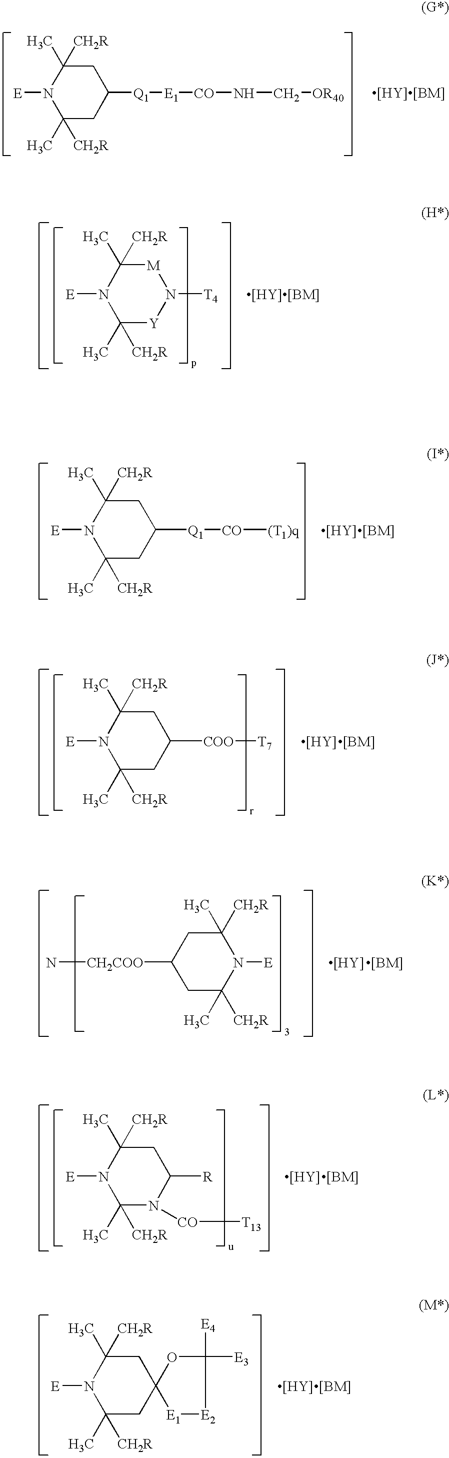 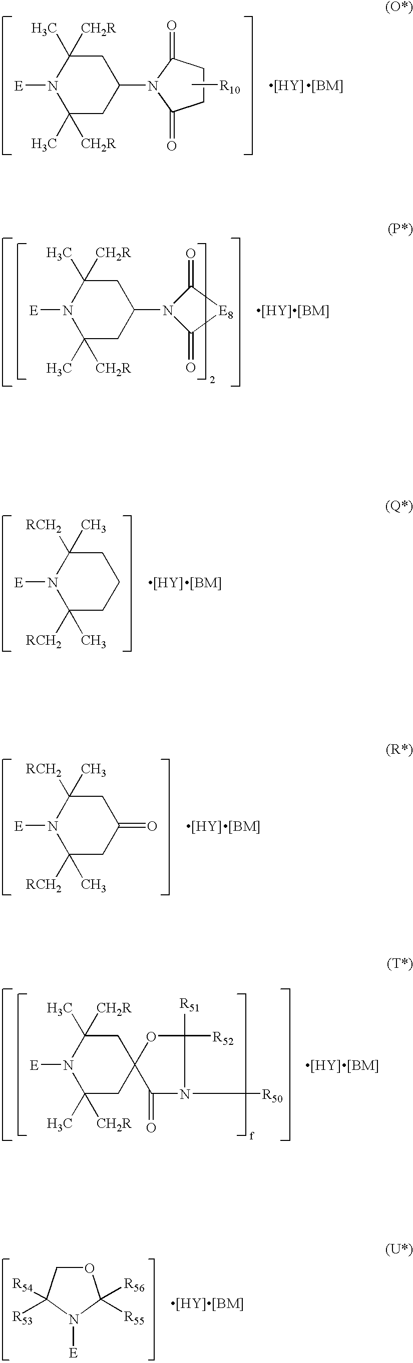 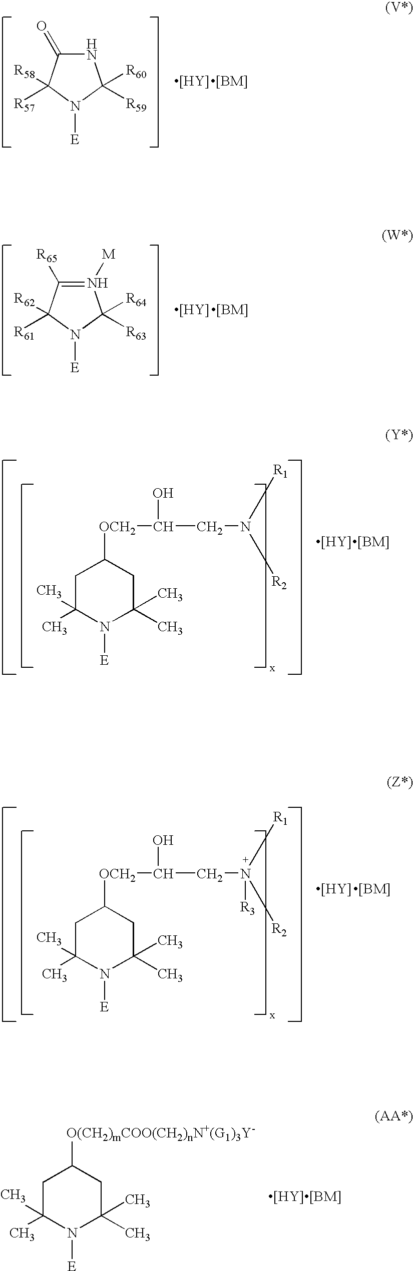 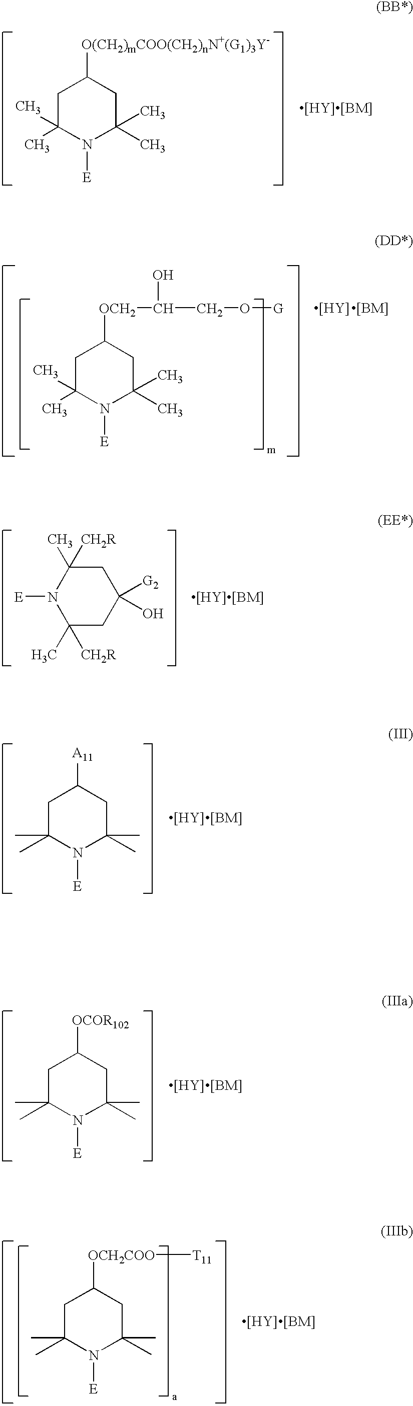 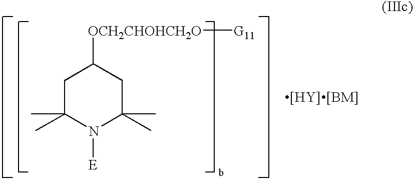
wherein
E is alkoxy of 1 to 18 carbon atoms, cycloalkoxy of 5 to 12 carbon atoms or aralkoxy of 7 to 15 carbon atoms, or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen or methyl; and
in formula (A*) n is 1 or 2,
when n is 1,
R₁ is hydrogen, alkyl of 1 to 18 carbon atoms, alkenyl of 2-18 carbon atoms, propargyl, glycidyl, alkyl of 2 to 50 carbon atoms interrupted by one to twenty oxygen atoms, said alkyl substituted by one to ten hydroxyl groups or both interrupted by said oxygen atoms and substituted by said hydroxyl groups, or
R₁ is alkyl of 1 to 4 carbon atoms substituted by a carboxy group or by —COOZ where Z is hydrogen, alkyl of 1 to 4 carbon atoms or phenyl, or where Z is said alkyl substituted by —(COO⁻)ₙ Mⁿ⁺ where n is 1-3 and M is a metal ion from the 1st, 2nd or 3rd group of the periodic table or is Zn, Cu, Ni or Co, or M is a group Nⁿ⁺(R₂)₄ where R₂ is alkyl of 1 to 8 carbon atoms or benzyl,
when n is 2,
R₁ is alkylene of 1 to 12 carbon atoms, alkenylene of 4 to 12 carbon atoms, xylylene or alkylene of 1 to 50 carbon atoms interrupted by one to twenty oxygen atoms, substituted by one to ten hydroxyl groups or both interrupted by said oxygen atoms and substituted by said hydroxyl groups;
in formula (B*), m is 1 to 4, and
when m is 1,
R₂ is alkyl of 1 to 18 carbon atoms, alkyl of 3 to 18 carbon atoms interrupted by —COO—, alkyl of 3 to 18 carbon atoms substituted by COOH or COO—, or R₂ is —CH₂(OCH₂CH₂)ₙOCH₃ where n is 1 to 12, or
R₂ is cycloalkyl of 5 to 12 carbon atoms, aryl of 6 to 12 carbon atoms, or said aryl substituted by one to four alkyl groups of 1 to 4 carbon atoms, or
R₂ is —NHR₃ where R₃ is alkyl of 1 to 18 carbon atoms, cycloalkyl of 5 to 12 carbon atoms, aryl of 6 to 12 carbon atoms, or said aryl substituted by one to four alkyl of 1 to 4 carbon atoms, or
R₂ is —N(R₃)₂ where R₃ is as defined above,
when m is 2,
R₂ is alkylene of 1 to 12 carbon atoms, alkenylene of 4 to 12 carbon atoms, xylylene, alkylene of 2 to 12 carbon atoms interrupted by —COO—, alkylene of 3 to 18 carbon atoms substituted by COOH or COO—, or R₂ is —CH₂(OCH₂CH₂)ₙOCH₂— where n is 1 to 12, or
R₂ is cycloalkylene of 5 to 12 carbon atoms, aralkylene of 7 to 15 carbon atoms or arylene of 6 to 12 carbon atoms, or
R₂ is —NHR₄NH— where R₄ is alkylene of 2 to 18 carbon atoms, cycloalkylene of 5 to 12 carbon atoms, aralkylene of 8 to 15 carbon atoms or arylene of 6 to 12 carbon atoms, or
R₂ is —N(R₃)R₄N(R₃)— where R₃ and R₄ are as defined above, or
R₂ is —CO—, —NH—CO—NH—, or —N(R3)-CO—N(R3)-,
when m is 3,
R₂ is alkanetriyl of 3 to 8 carbon atoms or benzenetriyl, or
when m is 4,
R₂ is alkanetetrayl of 5 to 8 carbon atoms or benzenetetrayl,
in formula (C*),
R₁₀ is hydrogen, alkyl of 1 to 18 carbon atoms, cycloalkyl of 5 to 12 carbon atoms, aralkyl of 7 to 15 carbon atoms, alkanoyl of 2 to 18 carbon atoms, alkenoyl of 3 to 5 carbon atoms or benzoyl,
x is 1 or 2, and
when x is 1,
R₁₁ is hydrogen, alkyl of 1 to 18 carbon atoms, alkenyl of 2 to 18 carbon atoms, propargyl, glycidyl, alkyl of 2 to 50 carbon atoms interrupted by one to twenty oxygen atoms, said alkyl substituted by one to ten hydroxyl groups or both interrupted by said oxygen atoms and substituted by said hydroxyl groups, or
R₁₁ is alkyl of 1 to 4 carbon atoms substituted by a carboxy group or by —COOZ where Z is hydrogen, alkyl of 1 to 4 carbon atoms or phenyl, or where Z is said alkyl substituted by —(COO⁻)ₙ Mⁿ⁺ where n is 1-3 and M is a metal ion from the 1st, 2nd or 3rd group of the periodic table or is Zn, Cu, Ni or Co, or M is a group Nⁿ⁺(R₂)₄ where R₂ is hydrogen, alkyl of 1 to 8 carbon atoms or benzyl, or
when x is 2,
R₁₁ is alkylene of 1 to 12 carbon atoms, alkenylene of 4 to 12 carbon atoms, xylylene or alkylene of 1 to 50 carbon atoms interrupted by one to twenty oxygen atoms, substituted by one to ten hydroxyl groups or both interrupted by said oxygen atoms and substituted by said hydroxyl groups,
in formula (D*), y is 1 to 4,
R₁₀ is as defined above,
and R₁₂ is defined as R₂ above,
in formula (E*), k is 1 or 2,
when k is 1,
R₂₀ and R₂₁ are independently alkyl of 1 to 12 carbon atoms, alkenyl of 2 to 12 carbon atoms or aralkyl of 7 to 15 carbon atoms, or R₂₀ is also hydrogen, or
R₂₀ and R₂₁ together are alkylene of 2 to 8 carbon atoms or said alkylene substituted by hydroxyl, or are acyloxy-alkylene of 4 to 22 carbon atoms, or
when k is 2,
R₂₀ and R₂₁ are together (—CH₂)₂C(CH₂—)₂,
in formula (F*),
R₃₀ is hydrogen, alkyl of 1 to 18 carbon atoms, benzyl, glycidyl, or alkoxyalkyl of 2 to 6 carbon atoms,
g is 1 or 2,
when g is 1, R₃₁ is defined as R₁ above when n is 1,
when g is 2, R₃₁ is defined as R₁ above when n is 2,
in formula (G*),
Q₁ is —NR₄₁— or —O—,
E₁ is alkylene of 1 to 3 carbon atoms, or E₁ is —CH₂—CH(R₄₂)—O— where R₄₂ is hydrogen, methyl or phenyl, or E₁ is —(CH₂)₃—NH— or E₁ is a direct bond,
R₄₀ is hydrogen or alkyl of 1 to 18 carbon atoms,
R₄₁ is hydrogen, alkyl of 1 to 18 carbon atoms, cycloalkyl of 5 to 12 carbon atoms, aralkyl of 7 to 15 carbon atoms, aryl of 6 to 10 carbon atoms, or R₄₁ is —CH₂—CH(R₄₂)—OH where R₄₂ is as defined above,
in formula (H*), p is 1 or 2,
T₄ is as defined for R₁₁ when x is 1 or 2,
M and Y are independently methylene or carbonyl, preferably M is methylene and Y is carbonyl,
in formula (I*),
this formula denotes a recurring structural unit of a polymer where T₁ is ethylene or 1,2-propylene or is the repeating structural unit derived from an alpha-olefin copolymer with an alkyl acrylate or methacrylate, and where
q is 2 to 100,
Q₁ is —N(R₄₁)— or —O— where R₄₁ is as defined above,
in formula (J*),
r is 1 or 2,
T₇ is as defined for R₁ when n is 1 or 2 in formula (A*),
preferably T₇ is octamethylene when r is 2,
in formula (L*), u is 1 or 2,
T₁₃ is as defined for R₁ when n is 1 or 2 in formula (A*), with the proviso that T₁₃ is not hydrogen when u is 1,
in formula (M*),
E₁ and E₂, being different, each are —CO— or —N(E₅)— where E₅ is hydrogen, alkyl of 1 to 12 carbon atoms or alkoxycarbonylalkyl of 4 to 22 carbon atoms, preferably E₁ is —CO— and E₂ is —N(E₅)-,
E₃ is hydrogen, alkyl of 1 to 30 carbon atoms, phenyl, naphthyl, said phenyl or said naphthyl substituted by chlorine or by alkyl of 1 to 4 carbon atoms, or phenylalkyl of 7 to 12 carbon atoms, or said phenylalkyl substituted by alkyl of 1 to 4 carbon atoms,
E₄ is hydrogen, alkyl of 1 to 30 carbon atoms, phenyl, naphthyl or phenylalkyl of 7 to 12 carbon atoms, or
E₃ and E₄ together are polymethylene of 4 to 17 carbon atoms, or said polymethylene substituted by one to four alkyl of 1 to 4 carbon atoms, preferably methyl,
in formula (O*),
R₁₀ is as defined for R₁₀ in formula (C*),
in formula (P*),
E₆ is an aliphatic or aromatic tetravalent radical, preferably neopentanetetrayl or benzenetetrayl,
in formula (T*),
R₅₁ is hydrogen, alkyl of 1 to 18 carbon atoms, cycloalkyl of 5 to 12 carbon atoms, or aryl of 6 to 10 carbon atoms,
R₅₂ is hydrogen or alkyl of 1 to 18 carbon atoms, or
R₅₁ and R₅₂ together of alkylene of 4 to 8 carbon atoms,
f is 1 or 2,
when f is 1,
R₅₀ is as defined for R₁₁ in formula (C*) when x is 1, or R₅₀ is —(CH₂)ₙCOOR₅₄ where z is 1 to 4 and R₅₄ is hydrogen or alkyl of 1 to 18 carbon atoms, or R₅₄ is a metal ion from the 1st, 2nd or 3rd group of the periodic table or a group —N(R₅₅)₄ where R₅₅ is hydrogen, alkyl of 1 to 12 carbon atoms or benzyl,
when f is 2,
R₅₀ is as defined for R₁₁ in formula (C*) when x is 2,
in formula (U*),
R₅₃, R₅₄, R₅₅ and R₅₆ are independently alkyl of 1 to 4 carbon atoms or are together pentamethylene,
in formula (V*),
R₅₇, R₅₈, R₅₉ and R₆₀ are independently alkyl of 1 to 4 carbon atoms or are together pentamethylene,
in formula (W*),
R₆₁, R₆₂, R₆₃ and R₆₄ are independently alkyl of 1 to 4 carbon atoms or are together pentamethylene,
R₆₅ is alkyl of 1 to 5 carbon atoms,
M is hydrogen or oxygen,
wherein in formulas (Y*) to (BB*),
n is 2 to 3,
G₁ is hydrogen, methyl, ethyl, butyl or benzyl,
m is 1 to 4,
x is 1 to 4,
when x is 1, R₁ and R₂ are independently alkyl of 1 to 18 carbon atoms, said alkyl interrupted by one to five oxygen atoms, said alkyl substituted by 1 to 5 hydroxyl groups or said alkyl both interrupted by said oxygen atoms and substituted by said hydroxyl groups; cycloalkyl of 5 to 12 carbon atoms, aralkyl of 7 to 15 carbon atoms, aryl of 6 to 10 carbon atoms or said aryl substituted by one to three alkyl of 1 to 8 carbon atoms, or R₁ is also hydrogen,
or R₁ and R₂ are together tetramethylene, pentamethylene, hexamethylene or 3-oxapentamethylene,
when x is 2,
R₁ is hydrogen, alkyl of 1 to 8 carbon atoms, said alkyl interrupted by one or two oxygen atoms, said alkyl substituted by a hydroxyl group, or said alkyl both interrupted by one or two oxygen atoms and substituted by a hydroxyl group,
R₂ is alkylene of 2 to 18 carbon atoms, said alkylene interrupted by one to five oxygen atoms, said alkylene substituted by 1 to 5 hydroxyl groups or said alkylene both interrupted by said oxygen atoms and substituted by said hydroxyl groups; o-, m- or p-phenylene or said phenylene substituted by one or two alkyl of 1 to 4 carbon atoms, or
R₂ is —(CH₂)ₖO[(CH₂)ₖO]ₕ(CH₂)ₖ— where k is 2 to 4 and h is 1 to 40, or
R₁ and R₂ together with the two N atoms to which they are attached are piperazin-1,4-diyl,
when x is 3,
R₁ is hydrogen,
R₂ is alkylene of 4 to 8 carbon atoms interrupted by one nitrogen atom,
when x is 4,
R₁ is hydrogen,
R₂ is alkylene of 6 to 12 carbon atoms interrupted by two nitrogen atoms,
R₃ is hydrogen, alkyl of 1 to 8 carbon atoms, said alkyl interrupted by one or two oxygen atoms, said alkyl substituted by a hydroxyl group, or both interrupted by one or two oxygen atoms and substituted by a hydroxyl group,
p is 2 or 3,
in formula (DD*),
m is 2 or 3,
when m is 2,
G is —(CH₂CHR—O)ᵣCH₂CHR—, where r is 0 to 3, and R is hydrogen or methyl, and
when m is 3, G is glyceryl,
in formula (EE*),
G₂ is —CN, —CONH₂ or —COOG₃ where G₃ is hydrogen, alkyl of 1 to 18 carbon atoms or phenyl,
in formulae (III) to (IIIc)
A11 is OR₁₀₁ or NR₁₁₁R₁₁₂
R₁₀₁ is alkenyl of 2 to 4 carbon atoms, propargyl, glycidyl, alkyl of 2 to 6 carbon atoms interrupted by one or two oxygen atoms, substituted by one to three hydroxyl groups or both interrupted by said oxygen atoms and substituted by said hydroxyl groups, or R₁₀₁ is alkyl of 1 to 4 carbon atoms substituted by carboxy or by the alkali metal, ammonium or C₁-C₄alkylammonium salts thereof; or R₁₀₁ is alkyl substituted by COOE₁₀ where E₁₀ is methyl or ethyl,
R₁₀₂ is alkyl of 3 to 5 carbon atoms interrupted by —COO— or by —CO—, or R₁₀₂ is —CH₂(OCH₂CH₂)_{c}COCH₃ where c is 1 to 4; or
R₁₀₂ is —NHR₁₀₃ where R₁₀₃ is alkyl of 1 to 4 carbon atoms,
a is 2 to 4,
when a is 2,
T₁₁ is —(CH₂CHR₁₀₀—O)_{d}CH₂CHR₁₀₀—, where d is 0 or 1, and R₁₀₀ is hydrogen or methyl,
when a is 3, T₁₁ is glyceryl,
when a is 4, T₁₁ is neopentanetetrayl,
b is 2 or 3,
when b is 2,
G₁₁ is —(CH₂CHR₁₀₀—O)_{d}CH₂CHR₁₀₀—, where d is 0 or 1, and R₁₀₀ is hydrogen or methyl, and
when b is 3, G₁₁ is glyceryl;
R₁₁₁ is hydrogen, unsubstituted alkyl of 1 to 4 carbon atoms, alkyl of 1 to 4 carbon atoms substituted by one or two hydroxyl, alkyl of 1 to 4 carbon atoms interrupted by one or two oxygen atoms, or both substituted by one hydroxyl and interrupted by one or two oxygen atoms,
R₁₁₂ is —CO—R₁₁₃ where R₁₁₃ has the same meaning as R₁₁₁, or R₁₁₃ is NHR₁₁₄, wherein R₁₁₄ is unsubstituted alkyl of 1 to 4 carbon atoms, alkyl of 1 to 4 carbon atoms substituted by one or two hydroxyl, alkyl of 1 to 4 carbon atoms substituted by alkoxy of 1 to 2 carbon atoms, or both substituted by one hydroxyl and by alkoxy of 1 to 2 carbon atoms, or
R₁₁₁ and R₁₁₂ together are —CO—CH₂CH₂—CO—, or (CH₂)₆CO—;
   BM is a basic material selected from the group consisting of alkali metal hydroxides, alkaline earth metal hydroxides, and amines;
   amines are R₁₁₅—N(R₁₁₆)—R₁₁₇, wherein
   R₁₁₅, R₁₁₆, and R₁₁₇ are independently hydrogen, straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or said alkyl substituted by one or more —OH, —OCO—R₁₁₈, —OR₁₁₉, or —NH₂ groups or mixtures thereof; or said alkyl or said alkenyl interrupted by one or more —O—, —NH— or —NR₁₁₉— groups or mixtures thereof and which can be unsubstituted or substituted by one or more —OH, —OR₁₁₉ or —NH₂ groups or mixtures thereof;
   R₁₁₈ is hydrogen, straight or branched chain C₁-C₁₈alkyl, C₅-C₁₂cycloalkyl, straight or branched chain C₃-C₈alkenyl, C₆-C₁₄aryl or C₇-C₁₅aralkyl,
   R₁₁₉ is straight or branched chain alkyl of 1 to 18 carbon atoms;
   alkali metal hydroxide is sodium hydroxide, potassium hydroxide, or rubidium hydroxide;
   alkaline earth metal hydroxide is magnesium hydroxide, calcium hydroxide, strontium hydroxide, or barium hydroxide;
   HY is an inorganic or organic acid; wherein the total charge of cations is equal to the total charge of anions; and
   Y is phosphate, phosphonate, carbonate, bicarbonate, nitrate, chloride, bromide, bisulfite, sulfite, bisulfate, sulfate, borate, formate, acetate, benzoate, citrate, oxalate, tartrate, acrylate, polyacrylate, fumarate, maleate, itaconate, glycolate, gluconate, malate, mandelate, tiglate, ascorbate, polymethacrylate, a carboxylate of nitrilotriacetic acid, a carboxlylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

Another embodiment of the instant invention is the compounds of formula (I) selected from the group consisting of (A*), (B*), (C*), (D*), (Q*), (R*), (Y*), and (Z*),

wherein

E is alkoxy of 1 to 10 carbon atoms, cycloalkoxy of 5 to 8 carbon atoms or aralkoxy of 7 to 12 carbon atoms, or E is —O-T-(OH)_{b},

T is a straight or branched chain alkylene of 1 to 10 carbon atoms, cycloalkylene of 5 to 10 carbon atoms, cycloalkenylene of 5 to 10 carbon atoms, a straight or branched chain alkylene of 1 to 4 carbon atoms substituted by phenyl or by phenyl substituted by one or two alkyl groups of 1 to 4 carbon atoms;

b is 1, 2 or 3 with the proviso that b cannot exceed the number of carbon atoms in T, and when b is 2 or 3, each hydroxyl group is attached to a different carbon atoms of T;

R is hydrogen;

in formula (A*), n is 1 or 2,

when n is 1,

R₁ is hydrogen, alkyl of 1 to 6 carbon atoms, alkenyl of 2-6 carbon atoms, propargyl, glycidyl, alkyl of 2 to 20 carbon atoms interrupted by one to ten oxygen atoms, said alkyl substituted by one to five hydroxyl groups or both interrupted by said oxygen atoms and substituted by said hydroxyl groups, or

R₁ is alkyl of 1 to 4 carbon atoms substituted by a carboxy group or by —COOZ where Z is hydrogen or alkyl of 1 to 4 carbon atoms,

when n is 2,

R₁ is alkylene of 1 to 8 carbon atoms, alkenylene of 4 to 8 carbon atoms, alkylene of 1 to 20 carbon atoms interrupted by one to ten oxygen atoms, substituted by one to five hydroxyl groups or both interrupted by said oxygen atoms and substituted by said hydroxyl groups,

in formula (B*), m is 1 or 2

when m is 1,

R₂ is alkyl of 1 to 4 carbon atoms or R₂ is CH₂(OCH₂CH₂)ₙOCH₃ where n is 1 to 12, or

R₂ is phenyl, or said phenyl substituted by one to three methyl groups, or

R₂ is —NHR₃ where R₃ is alkyl of 1 to 4 carbon atoms or phenyl, or said phenyl substituted by one or two methyl groups,

when m is 2,

R₂ is alkylene of 1 to 8 carbon atoms, alkenylene of 4 to 8 carbon atoms, or R₂ is —CH₂(OCH₂CH₂)ₙOCH₂— where n is 1 to 12, or

R₂ is —NHR₄NH— where R₄ is of 2 to 6 carbon atoms, aralkylene of 8 to 15 carbon atoms or arylene of 6 to 12 carbon atoms, or

R₂ is —CO— or —NHCONH—,

in formula (C*),

R₁₀ is hydrogen or, alkanoyl of 1 to 3 carbon atoms,

x is 1 or 2,

when x is 1,

R₁₁ is hydrogen, alkyl of 1 to 6 carbon atoms or glycidyl, or

R₁₁ is alkyl of 1 to 4 carbon atoms substituted by a carboxy group or by COOZ where Z is hydrogen or alkyl of 1 to 4 carbon atoms,

when x is 2,

R₁₁ is alkylene of 1 to 6 carbon atoms,

in formula (D*),

R₁₀ is hydrogen,

y is 1 or 2,

R₁₂ is defined as R₂ above,

in formula (Y*) and (Z*),

x is 1 or 2,

when x is 1,

R₁ and R₂ are independently alkyl of 1 to 4 carbon atoms or R₁ and R₂ are together tetramethylene, or pentamethylene,

R₂ is hydrogen or alkyl of 1 to 4 carbon atoms, said alkyl group substituted by a hydroxyl group,

when x is 2,

R₁ is hydrogen, alkyl of 1 to 4 carbon atoms, said alkyl substituted by a hydroxyl group,

R₂ is alkylene of 2 to 6 carbon atoms,

R₃ is as defined above,

BM is a basic material selected from the group consisting of alkali metal hydroxides, alkaline earth metal hydroxides, and amines;

amines are R₁₁₅—N(R₁₁₆)—R₁₁₇, wherein

R₁₁₅, R₁₁₆, and R₁₁₇ are independently hydrogen, straight or branched alkyl chain of 1 to 18 carbon atoms, straight or branched chain alkenyl of 2 to 12 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or said alkyl substituted by one or more —OH, —OR₁₁₉, or —NH₂ groups or mixtures thereof; or said alkyl or said alkenyl interrupted by one or more —O—, NH— or —NR₁₁₉— groups or mixtures thereof and which can be unsubstituted or substituted by one or more —OH, —OR₁₁₉ or —NH₂ groups or mixtures thereof;

R₁₁₉ is straight or branched chain alkyl of 1 to 12 carbon atoms;

alkali metal hydroxide is sodium hydroxide or potassium hydroxide;

alkaline earth metal hydroxide is magnesium hydroxide or calcium hydroxide;

HY is an inorganic or organic acid; and, wherein the total charge of cations is equal to the total charge of anions; and

Y is phosphate, phosphonate, carbonate, bicarbonate, chloride, bromide, bisulfate, sulfate, borate, formate, acetate, benzoate, citrate, oxalate, tartrate, acrylate, fumarate, maleate, itaconate, glycolate, gluconate, malate, mandelate, tiglate, ascorbate, a carboxylate of nitrilotriacetic acid, a carboxylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

Still another embodiment of the instant invention is the compounds of formula (I) selected from the group consisting of (A*), (B*), (C*), (D*), (Q*), and (R*),

wherein

E is alkoxy of 1 to 10 carbon atoms, cycloalkoxy of 5 to 8 carbon atoms or aralkoxy of 7 to 12 carbon atoms, or E is —O-T-(OH)_{b},

T is a straight or branched chain alkylene of 1 to 10 carbon atoms, cycloalkylene of 5 to 10 carbon atoms, cycloalkenylene of 5 to 10 carbon atoms, a straight or branched chain alkylene of 1 to 4 carbon atoms substituted by phenyl or by phenyl substituted by one or two alkyl groups of 1 to 4 carbon atoms;

b is 1, 2 or 3 with the proviso that b cannot exceed the number of carbon atoms in T, and when b is 2 or 3, each hydroxyl group is attached to a different carbon atoms of T;

R is hydrogen,

in formula (A*),

h is 1,

R₁ is hydrogen, alkyl of 1 to 4 carbon atoms, glycidyl, alkyl of 2 to 4 carbon atoms interrupted by one or two oxygen atoms, said alkyl substituted by one or two hydroxyl groups or both interrupted by said oxygen atoms and substituted by said hydroxyl groups, or

R₁ is alkyl of 1 to 4 carbon atoms substituted by —COOZ where Z is hydrogen or alkyl of 1 to 4 carbon atoms,

in formula (B*),

m is 1 or 2,

R₂ is alkyl of 1 to 4 carbon atoms or R₂ is CH₂(OCH₂CH₂)ₙOCH₃ where n is 1 to 4,

when m is 2,

R₂ is alkylene of 1 to 8 carbon atoms,

in formula (C*),

R₁₀ is hydrogen or alkanoyl of 1 or 2 carbon atoms,

x is 1 or 2,

when x is 1,

R₁₁ is hydrogen, alkyl of 1 to 4 carbon atoms or glycidyl,

R₁₁ is alkyl of 1 to 4 carbon atoms substituted by COOZ where Z is hydrogen or alkyl of 1 to 4 carbon atoms,

when x is 2,

R₁₁ is alkylene of 1 to 6 carbon atoms,

in formula (D*),

R₁₀ is hydrogen,

y is 1 or 2,

R₁₂ is defined as R₂ above;

when x is 1,

R₁₁ is hydrogen, alkyl of 1 to 6 carbon atoms or glycidyl, or

R₁₁ is alkyl of 1 to 4 carbon atoms substituted by a carboxy group or by COOZ where Z is hydrogen or alkyl of 1 to 4 carbon atoms,

when x is 2,

R₁₁ is alkylene of 1 to 6 carbon atoms,

in formula (D*),

R₁₀ is hydrogen,

y is 1 or 2,

R₁₂ is defined as R₂ above,

in formula (Y*) and (Z*),

x is 1 or 2,

when x is 1,

R₁ and R₂ are independently alkyl of 1 to 4 carbon atoms or R₁ and R₂ are together tetramethylene, or pentamethylene,

R₂ is hydrogen or alkyl of 1 to 4 carbon atoms, said alkyl group substituted by a hydroxyl group,

when x is 2,

R₁ is hydrogen, alkyl of 1 to 4 carbon atoms, said alkyl substituted by a hydroxyl group,

R₂ is alkylene of 2 to 6 carbon atoms,

R₃ is as defined above,

BM is a basic material selected from the group consisting of alkali metal hydroxides, alkaline earth metal hydroxides, and amines;

amines are R₁₁₅—N(R₁₁₆)—R₁₁₇, wherein

R₁₁₅, R₁₁₆, and R₁₁₇ are independently hydrogen, straight or branched alkyl chain of 1 to 12 carbon atoms, or said alkyl substituted by one or more —OH, —OR₁₁₉, or —NH₂ groups or mixtures thereof; or said alkyl interrupted by one or more —O—, —NH— or —NR₁₁₉— groups or mixtures thereof and which can be unsubstituted or substituted by one or more —OH, —OR₁₁₉ or —NH₂ groups or mixtures thereof;

R₁₁₉ is straight or branched chain alkyl of 1 to 8 carbon atoms;

Alkali metal hydroxide is sodium hydroxide or potassium hydroxide;

Alkaline earth metal hydroxide is calcium hydroxide;

HY is an inorganic or organic acid; and, wherein the total charge of cations is equal to the total charge of anions; and

Y is phosphate, phosphonate, carbonate, bicarbonate, chloride, bromide, bisulfate, sulfate, borate, formate, acetate, benzoate, citrate, oxalate, tartrate, ascorbate, acrylate, fumarate, maleate, itaconate, glycolate, gluconate, malate, mandelate, tiglate, a carboxylate of nitrilotriacetic acid, a carboxylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

Yet another embodiment of the instant invention is a compound of formula (I) selected from the group consisting of
(a) Monosodium 1-methoxy-2,2,6,6-tetramethyl-4-acetoxypiperidinium citrate;
(b) Monopotassium 1-methoxy-2,2,6,6-tetramethyl-4-acetamidopiperidinium phosphate;
(c) Monoammonium 1-butoxy-2,2,6,6-tetramethyl-4-acetamidopiperidinium sulfate;
(d) Mono-(N,N,N-triethylammonium) 1-phenoxy-2,2,6,6-tetramethyl-4-methoxy-piperidinium tartrate;
(e) Mono-[N,N-di-n-butyl ammonium]1-ethoxy-2,2,6,6-tetramethyl-4-acetoxypiperidinium maleate;
(f) Mono-[N,N,N-(2-hydroxyethyl)ammonium]1-methoxy-2,2,6,6-tetramethyl-4-propoxypiperidinium oxalate;
(g) Monosodium 1-methoxy-2,2,6,6-tetramethyl-4-(2-hydroxy-4-oxapentoxy)piperidinium carbonate;
(h) Dipotassium 1-(2-hydroxy-2-methylpropoxy)-2,2,6,6-tetramethyl-4-hydroxypiperidinium citrate;
(i) Monosodium bis(1-(2-hydroxy-2-methylpropoxy)-2,2,6,6-tetramethyl-4-hydroxypiperidinium) citrate;
(j) Diammonium (1-(2-hydroxy-2-methylpropoxy)-2,2,6,6-tetramethyl-4-hydroxypiperidinium) citrate;
(k) Monopotassium monosodium bis(1-(2-hydroxy-2-methylpropoxy)-2,2,6,6-tetramethyl-4-hydroxypiperidinium)ethylenediaminetetraacetate;
(l) Monosodium tris(1-(2-hydroxy-2-methylpropoxy)-2,2,6,6-tetramethyl-4-acetamidopiperidinium)ethylenediaminetetraacetate;
(m) Monocalcium bis(1-(2-hydroxy-2-methylpropoxy)-2,2,6,6-tetramethyl-4-oxopiperidinium)ethylenediaminetetraacetate;
(n) Monoammonium tetra(1-(2-hydroxy-2-methylpropoxy)-2,2,6,6-tetramethyl-4-hydroxypiperidinium) diethylenetriaminepentaacetate;
(o) Disodium tris(1-(2-hydroxy-2-methylpropoxy)-2,2,6,6-tetramethyl-4-acetamidopiperidinium) diethylenetriaminepentaacetate;
(p) Tripotassium di(1-(2-hydroxy-2-methylpropoxy)-2,2,6,6-tetramethyl-4-oxopiperidinium) diethylenetriaminepentaacetate;
(q) Monobenzylammonium bis(1-(2-hydroxy-2-methylpropoxy)-2,2,6,6-tetramethyl-4-hydroxypiperidinium)nitrilotriacetate;
(r) Di-[N,N-diethylammonium]mono(1-(2-hydroxy-2-methylpropoxy)-2,2,6,6-tetramethyl-4-acetamidopiperidinium)nitrilotriacetate;
(s) Monosodium bis(1-(2-hydroxy-2-methylpropoxy)-2,2,6,6-tetramethyl-4-oxopiperidinium)nitrilotriacetate;
(t) Diammonium tris(1-(2-hydroxy-2-methylpropoxy)-2,2,6,6-tetramethyl-4-hydroxypiperidinium) diethylenetriaminepentamethylenephosphonate;
(u) Monosodium tetra(1-(2-hydroxy-2-methylpropoxy)-2,2,6,6-tetramethyl-4-acetamidopiperidinium) diethylenetriaminepentamethylenephosphonate; and,
(v) Tripotassium bis(1-(2-hydroxy-2-methylpropoxy)-2,2,6,6-tetramethyl-4-oxopiperidinium) diethylenetriaminepentamethylenephosphonate.

Another embodiment of the invention relates to an ink-jet ink, ink-jet recording material or ink-jet system comprising at least one compound of formula (I) selected from the group consisting of formulae (A*), (B*), (C*), (D*), (Q*), and (R*),

wherein

E is alkoxy of 1 to 10 carbon atoms, cycloalkoxy of 5 to 8 carbon atoms or aralkoxy of 7 to 12 carbon atoms, or E is —O-T-(OH)_{b},

T is a straight or branched chain alkylene of 1 to 10 carbon atoms, cycloalkylene of 5 to 10 carbon atoms, cycloalkenylene of 5 to 10 carbon atoms, a straight or branched chain alkylene of 1 to 4 carbon atoms substituted by phenyl or by phenyl substituted by one or two alkyl groups of 1 to 4 carbon atoms;

b is 1, 2 or 3 with the proviso that b cannot exceed the number of carbon atoms in T, and when b is 2 or 3, each hydroxyl group is attached to a different carbon atoms of T;

R is hydrogen,

in formula (A*),

n is 1,

R₁ is hydrogen, alkyl of 1 to 4 carbon atoms, glycidyl, alkyl of 2 to 4 carbon atoms interrupted by one or two oxygen atoms, said alkyl substituted by one or two hydroxyl groups or both interrupted by said oxygen atoms and substituted by said hydroxyl groups, or

R₁ is alkyl of 1 to 4 carbon atoms substituted by —COOZ where Z is hydrogen or alkyl of 1 to 4 carbon atoms,

in formula (B*),

m is 1 or 2,

when m is 1,

R₂ is alkyl of 1 to 4 carbon atoms or R₂ is CH₂(OCH₂CH₂)ₙOCH₃ where n is 1 to 4,

when m is 2,

R₂ is alkylene of 1 to 8 carbon atoms,

in formula (C*),

R₁₀ is hydrogen or alkanoyl of 1 or 2 carbon atoms,

x is 1 or 2,

when x is 1,

R₁₁ is hydrogen, alkyl of 1 to 4 carbon atoms or glycidyl,

R₁₁ is alkyl of 1 to 4 carbon atoms substituted by COOZ where Z is hydrogen or alkyl of 1 to 4 carbon atoms,

when x is 2,

R₁₁ is alkylene of 1 to 6 carbon atoms,

in formula (D*),

R₁₀ is hydrogen,

y is 1 or 2,

R₁₂ is defined as R₂ above;

BM is a basic material selected from the group consisting of alkali metal hydroxides, alkaline earth metal hydroxides, and amines;

amines are R₁₁₅—N(R₁₁₆)—R₁₁₇, wherein

R₁₁₅, R₁₁₆, and R₁₁₇ are independently hydrogen, straight or branched alkyl chain of 1 to 12 carbon atoms, or said alkyl substituted by one or more —OH, —OR₁₁₉, or —NH₂ groups or mixtures thereof; or said alkyl interrupted by one or more —O—, —NH— or —NR₁₁₉— groups or mixtures thereof and which can be unsubstituted or substituted by one or more —OH, —OR₁₁₉ or —NH₂ groups or mixtures thereof;

R₁₁₉ is straight or branched chain alkyl of 1 to 8 carbon atoms;

Alkali metal hydroxide is sodium hydroxide or potassium hydroxide;

HY is an inorganic or organic acid; and, wherein the total charge of cations is equal to the total charge of anions; and

Y is phosphate, phosphonate, carbonate, bicarbonate, chloride, bromide, bisulfate, sulfate, borate, formate, acetate, benzoate, citrate, oxalate, tartrate, acrylate, fumarate, maleate, itaconate, glycolate, gluconate, malate, mandelate, tiglate, a carboxylate of nitrilotriacetic acid, ascorbate, hydroxyethylethylenediaminetriacetic acid, ethylenediaminetetraacetic acid or of diethylenetriaminepentaacetic acid, a diethylenediaminetetraacetic acid or of diethylenetriaminepentaacetic acid, alkylsulfonate, arylsulfonate or alkyl-substituted arylsulfonate.

Another embodiment of the invention relates to an ink-jet ink, ink-jet recording material or ink-jet system comprising at least one compound of formula (I) selected from the group consisting of
(a) Monosodium 1-methoxy-2,2,6,6-tetramethyl-4-acetoxypiperidinium citrate;
(b) Monopotassium 1-methoxy-2,2,6,6-tetramethyl-4-acetamidopiperidinium phosphate;
(c) Monoammonium 1-butoxy-2,2,6,6-tetramethyl-4-acetamidopiperidinium sulfate;
(d) Mono-(N,N, N-triethylammonium) 1-phenoxy-2,2,6,6-tetramethyl-4-methoxy-piperidinium tartrate;
(e) Mono-[N,N-di-n-butyl ammonium]1-ethoxy-2,2,6,6-tetramethyl-4-acetoxypiperidinium maleate;
(f) Mono-[N,N,N-(2-hydroxyethyl)ammonium]1-methoxy-2,2,6,6-tetramethyl-4-propoxypiperidinium oxalate;
(g) Monosodium 1-methoxy-2,2,6,6-tetramethyl-4-(2-hydroxy-4-oxapentoxy)piperidinium carbonate;
(h) Dipotassium 1-(2-hydroxy-2-methylpropoxy)-2,2,6,6-tetramethyl-4-hydroxypiperidinium citrate;
(i) Monosodium bis(1-(2-hydroxy-2-methylpropoxy)-2,2,6,6-tetramethyl-4-hydroxypiperidinium) citrate;
(j) Diammonium (1-(2-hydroxy-2-methylpropoxy)-2,2,6,6-tetramethyl-4-hydroxypiperidinium) citrate;
(k) Monopotassium monosodium bis(1-(2-hydroxy-2-methylpropoxy)-2,2,6,6-tetramethyl-4-hydroxypiperidinium)ethylenediaminetetraacetate;
(l) Monosodium tris(1-(2-hydroxy-2-methylpropoxy)-2,2,6,6-tetramethyl-4-acetamidopiperidinium)ethylenediaminetetraacetate;
(m) Monocalcium bis(1-(2-hydroxy-2-methylpropoxy)-2,2,6,6-tetramethyl-4-oxopiperidinium)ethylenediaminetetraacetate;
(n) Monoammonium tetra(1-(2-hydroxy-2-methylpropoxy)-2,2,6,6-tetramethyl-4-hydroxypiperidinium) diethylenetriaminepentaacetate;
(o) Disodium tris(1-(2-hydroxy-2-methylpropoxy)-2,2,6,6-tetramethyl-4-acetamidopiperidinium) diethylenetriaminepentaacetate;
(p) Tripotassium di(1-(2-hydroxy-2-methylpropoxy)-2,2,6,6-tetramethyl-4-oxopiperidinium) diethylenetriaminepentaacetate;
(q) Monobenzylammonium bis(1-(2-hydroxy-2-methylpropoxy)-2,2,6,6-tetramethyl-4-hydroxypiperidinium)nitrilotriacetate;
(r) Di-[N,N-diethylammonium]mono(1-(2-hydroxy-2-methylpropoxy)-2,2,6,6-tetramethyl-4-acetamidopiperidinium)nitrilotriacetate;
(s) Monosodium bis(1-(2-hydroxy-2-methylpropoxy)-2,2,6,6-tetramethyl-4-oxopiperidinium)nitrilotriacetate;
(t) Diammonium tris(1-(2-hydroxy-2-methylpropoxy)-2,2,6,6-tetramethyl-4-hydroxypiperidinium) diethylenetriaminepentamethylenephosphonate;
(u) Monosodium tetra(1-(2-hydroxy-2-methylpropoxy)-2,2,6,6-tetramethyl-4-acetamidopiperidinium) diethylenetriaminepentamethylenephosphonate; and,
(v) Tripotassium bis(1-(2-hydroxy-2-methylpropoxy)-2,2,6,6-tetramethyl-4-oxopiperidinium) diethylenetriaminepentamethylenephosphonate.

The compounds of formula (I) can be prepared according to methods known in the art or in analogy to those methods.

The compounds of formula (I) are used either in the ink-jet recording material or in at least one ink-jet ink or in both.

The ink-jet ink according to this invention preferably contains about 0.01 to about 30% by weight, in particular about 0.1 to about 20% by weight, of at least one compound of formula (I).

The ink-jet recording material according to this invention preferably contains about 1 to about 10000 mg/m², based on the weight of the entire ink, most preferably about 50 to about 2000 mg/m², of at least one compound of the formula (I).

Compounds of formula (I) are preferably added to casting or coating dispersions which are applied by customary techniques to the support of the ink-jet recording material, or they can be absorbed onto the material from an aqueous or organic solution. If the recording material contains more than one layer, the compounds according to this invention can be added to one layer or can be distributed over a plurality of layers, wherein they can be applied to a plurality of layers in the same or different concentrations.

Compounds of formula (I) are preferably used in ink-jet inks or recording materials, but may also be incorporated in ink compositions for felt-tipped pens, ink pads, fountain pens, and pen plotters, as well as for offset, book, flexographic and intaglio printing, and also for typewriter ribbons for dot matrix and calligraphic printing. Compounds of formula (I) can further be used in silver halide photographic materials as well as in recording materials for pressure-sensitive copying systems, microcapsule photocopier systems, heat-sensitive copier systems, dye diffusion transfer printing, thermal wax transfer printing and dot matrix printing, and for use with electrostatic, electrographic, electrophoretic, magnetographic and laser-electrophotographic printers, recorders or plotters.

Amongst the printers used for ink-jet printing, a distinction is usually made between continuous and drop-on-demand printers. The ink-jet system according to this invention is suited for use with both types of printers.

The ink compositions according to the novel ink-jet system are preferably water-borne inks and may contain water-soluble solvents such as ethylene glycol, diethylene glycol, triethylene glycol or higher ethylene glycols, propylene glycol, 1,4-butanediol, or ethers of such glycols, thiodiglycol, glycerol and the ethers and esters thereof, polyglycerol, mono-, di- and triethanolamine, propanolamine, dimethyl formamide, dimethyl sulfoxide, dimethyl acetamide, N-methylpyrrolidone, 1,3-dimethylimidazolidone, methanol, ethanol, isopropanol, n-propanol, diacetone alcohol, acetone, methyl ethyl ketone or propylene carbonate.

The ink compositions according to the novel ink-jet system preferably contain water-soluble dyes, such as those known for dyeing natural fibres. These can, for example, be acid dyes, direct dyes, reactive dyes, mono-, di- or polyazo dyes, triphenylmethane dyes, xanthene dyes or phtalocyanine dyes. Specific examples of such dyes are Food Black 2, Direct Black 19, Direct Black 38, Direct Black 168, Sulphur Black 1, Acid Red 14, Acid Red 35, Acid Red 52, Acid Red 249, Direct Red 227, Reactive Red 24, Reactive Red 40, Reactive Red 120, Reactive Red 159, Reactive Red 180, Acid Yellow 17, Acid Yellow 23, Direct Yellow 86, Direct Yellow 132, Acid blue 9, Acid Blue 185, Direct Blue 86, Direct Blue 199, copper phtalocyanines and the azo dyes listed in EP-A-366 221.

The ink compositions according to the invention may be non-aqueous and consist of a solution of dyes in an organic solvent or a mixture of organic solvents. Examples of solvents used for this purpose are alkyl carbitols, alkylcellosolves, dialkylformamides, dialkylacetamides, alcohols, acetone, methylethylketone, diethylketone, diethyl ketone, methyl isobutyl ketone, diisopropyl ketone, dibutyl ketone, dioxane, ethyl butyrate, ethyl isovalerate, diethyl malonate, diethyl succinate, butyl acetate, triethyl phosphate, ethylglycol acetate, toluene, xylene, tetralin or petroleum fractions. Example of solid waxes as solvents, which, as an ink carrier, must first be heated, are stearic or palmiric acid. Solvent-based inks contain dyes soluble therein, for example Solvent Red, Solvent Yellow, Solvent Orange, Solvent Blue, Solvent Green, Solvent Violet, Solvent Brown or Solvent Black.

The ink compositions according to the novel ink-jet system may also contain minor amounts of conventional modifiers such as binders, surfactants, biocides, corrosion inhibitors, sequestrants, pH buffers or conductivity additives. They may also contain further light stabilisers or UV absorbers, including the compounds disclosed in U.S. Pat. No. 5,073,448, U.S. Pat. No. 5,089,050, U.S. Pat. No. 5,096,489, U.S. Pat. No. 5,124,723, U.S. Pat. No. 5,098,477 and U.S. Pat. No. 5,509,957.

The ink compositions according to the invention may also consist of more than one phase. Ink compositions that consist of an aqueous phase in which the dye is dissolved and a dispersed oil phase that contains an UV absorber and/or an antioxidant are for example disclosed in JP-A-0 1170 675, JP-A-0 1182 379, JP-A-0 1182 380, JP-A-01182 381, JP-A-0 1193 376. Oil soluble dyes can be dissolved in an oil together with UV absorbers and/or antioxidants. The oil is either emulsified or dispersed in an aqueous phase as described, inter alia, in JP-A-0 1170 674 and JP-A-0 1170 672.

Further suited ink-jet ink compositions are described in EP-A-672 538, pages 3 to 6.

The recording materials according to the novel ink-jet system consist of a substrate having a surface which is printable by means of an ink-jet. The substrate is usually plain paper or polyolefine-laminated paper or a plastic sheet and is usually coated with at least one layer which is able to absorb ink. The substrate preferably has a thickness of 80 to 250 micrometers.

Uncoated paper might also be used. In this case, the paper acts simultaneously as substrate and ink absorbing layer. Materials made of cellulosic fibres and textile fibres materials such as cotton fabrics or blends of cotton and polyacrylamide or polyester, which might contain compounds of formula (I), can also be used as printing materials.

The recording materials may also be transparent, as in the case of overhead projection transparencies.

The compounds of formula (I) can be incorporated in the substrate during production thereof, conveniently by addition to the pulp during paper manufacture. Another method of application consists in spraying the substrate with a solution of the compounds of formula (I) in water or in a readily volatile organic solvent. The use of emulsions or dispersions is also possible.

Usually, however, at least one coating composition with high dye affinity is coated onto the substrate and, in this case, the compounds of formula (I) are added to at least one of the said coating compositions. Typical coating compositions comprise, for example, a solid filler, a binder and conventional additives.

Example of suitable fillers are SiO₂, kaolin, talc, clay, calcium silicate, magnesium silicate, aluminium silicate, gypsum, zeolites, bentonite, diatomaceous earth, vermiculite, starch or the surface modified SiO₂ described in JP-A-60 260 377. Small amounts of white pigments, for example titanium dioxide, barytes, magnesium oxide, lime, chalk or magnesium carbonate, can be used with the filler in the coating composition, provided they do not significantly lower the print density of the ink-jet prints.

Coating compositions which are intended for transparent, projectable recording materials must not contain any light-scattering particles, such as pigments and fillers.

The binder binds the fillers to one another and to the substrate. Typical conventional binders are water-soluble polymers such as polyvinyl alcohol, partially hydrolysed polyvinyl acetate, cellulose and cellulose derivatives such as hydroxyethyl cellulose, polyvinyl pyrrolidone and copolymers thereof, polyethylene oxide, salts of polyacrylic acid, sodium alginate, starch and starch derivatives, Na alginate, polyethylene imine, polyvinylpyridinium halide, gelatines and gelatine derivatives such as phthaloyl gelatines, casein, vegetable gum, dextrin, albumin, dispersions and polyacrylates or acrylate/methacrylate copolymers, lattices of natural or synthetic rubber, poly(meth)acrylamide, polyvinyl ethers, polyvinyl esters, copolymers of maleic acid, melamine resins, urea resins, water soluble polyurethanes and polyesters, or the chemically modified polyvinyl alcohols disclosed in JP-A-61 134 290 or JP-A-61 134 291.

An additional dye receptor or a mordant which enhances the fixation of the dye to the coating may be added to the binder. Dye receptors for acid dyes are cationic or amphoteric. The cationic mordants can be soluble or dispersible in water. Exemplary cationic mordants are polymeric ammonium compounds such as polyvinylbenzyldi- or trialkylammonium compounds, optionally quaternized poly(di)allylammonium compounds, polymethacryloxyethyldimethylhydroxyethylammonium chloride, polyvinylbenzylmethylimidazolium chloride, polyvinylbenzylpicolinium chloride or polyvinylbenzyltributylammonium chloride. Further examples are basic polymers such as poly(dimethylaminoethyl)methacrylate, polyalkylenepolyamines and their condensation products with dicyanodiamide, amine/epichlorohydrin polycondensates or the compounds disclosed in JP-A-57-36692, 57-64591, 57-187289, 57-191084, 58-177390, 58-208357, 59-20696, 59-33176, 59-96987, 59-198188, 60-49990, 60-71796, 60-72785, 60-161188, 60-187 582, 60-189481, 60-189482, 61-14979, 61-43593, 61-57379, 61-57380, 61-58788, 61-61887, 61-63477, 61-72581, 61-95977, 61-134291 or in U.S. Pat. Nos. 4,547,405 and 4,554,181 as well as in DE-A-3417582 and EP-B-609 930. The mordants used can also be compounds containing phosphonium groups (EP-B-609 930) as well as ground cationic ion exchange resins which are introduced in the mordant layer in a finely divided form. Further suitable cationic mordants are described in U.S. Pat. No. 6,102,997, pages 12 to 17. The cationic mordants can be soluble or dispersible in water and have an average molecular weight (weight average) of preferably at least 2,000 and, in particular, at least 20,000.

Besides the dye acceptor layer(s), the ink-jet recording material might comprise other layers on the ink receiving side, which are intended, for example, for providing scratch resistance, absorbing water or controlling whiteness and/or glossiness. The backside of the substrate might also be coated with at least one binder layer, in order to prevent buckling of the recording material.

The ink-jet recording material might also contain a number of other additives such as antioxidants, further light stabilizers (also including UV absorbers), viscosity improvers, fluorescent whitening agents, biocides, wetting agents, emulsifiers and spacers.

Suitable spacers are in particular spherical, have an average diameter of 1 to 50 micrometers, and in particular 5 to 20 micrometers, and have a narrow particle size distribution. Suitable spacers consist, for example, of polymethylmethacrylate, polystyrene, polyvinyl toluene, silicon dioxide and insoluble starch.

Illustrative examples of particularly suitable antioxidants are sterically hindered phenols, hydroquinones and hydroquinone ethers, for example the antioxidants disclosed in GB-A-2 088 777 or JP-A-60-72785, JP-A-O-72786 and JP-A-60-71796.

Illustrative examples of particularly suitable light stabilizers are organic nickel compounds and sterically hindered amines, for example the light stabilizers disclosed in JP-A-58-152072, 61-146591, 61-163886, 60-72785 and 61-146591 or in EP 373 573, 685 345 and 704 316, GB-A-2 088 777, JP-A-59-169883 and 61-177279.

Suitable UV absorbers are disclosed, inter alia, in Research Disclosure No. 24239 (1984) page 284, 37254 part VIII (1995) page 292, 37038 part X (1995) page 85 and 38957 part VI (1996), GB-A-2 088 777, EP 280 650, EP 306 083 and EP 711 804. These compounds are preferably introduced into the layer(s) farthest from the support. In a particular embodiment, the UV absorbers are contained in a layer above the layer(s) containing the compounds of the formula (I). Suitable UV absorbers for concurrent use with a compound of formula (I) in recording materials for ink-jet printing are in particular those of the 2′-hydroxyphenylbenzotriazole and 2′-hydroxyphenyltriazine class and, most particularly, 2-(2′-hydroxy-3′,5′-di-tertamylphenyl)benzotriazole and 2-(2′-hydroxy-3′-tert-butyl-5′-polyglycolpropionate-phenyl)benzotriazole. Further examples of particularly suited UV absorbers are listed in U.S. Pat. No. 6,102,997 pages 18-19. The UV absorbers can be soluble or insoluble in water and added to the coating composition as dispersion or emulsion, optionally together with high-boiling solvents, using suitable dispersing agents or emulsifiers. Suitable high boiling solvents are described in Research Disclosure No. 37254 part VIII (1995) page 292.

The binders in the individual layers, and in particular gelatines, can also be crosslinked by suitable compounds, so-called hardening agents, in order to improve the water and scratch resistance of the layers. Suitable hardening agents are described in Research Disclosure No. 37254 part IX (1995) page 294, 37038 part XII (1995) page 86 and 38957 part IIB (1996) page 599 et seq. The hardening agents are normally used in quantities of 0.005 to 10% by weight, and preferably 0.01 to 1% by weight, based on the binder to be hardened.

The ink-jet recording material can be produced in one pass from the support material and a casting solution for each layer to be applied, by means of a cascade or curtain casting device of the kind known from the production of photographic silver halide materials. After the casting solution(s) has/have been cast on the support, the material is dried and is then ready for use. The individual layers have a dry layer thickness of 0.1 to 20 micrometers, and preferably 0.5 to 5 micrometers.

Compounds of formula (I) can be dissolved either directly in the ink or coating composition or added thereto in the form of an emulsion or suspension. As already mentioned, the compounds of formula (I) can be also applied to the recording material in a separate operation, alone or together with other already described components, as a solution in water or in a suitable organic solvent. Application can be made by spraying, by sizing in a sizing press, by a separate coating operation or by immersion in a vat. After subjecting the recording material to such an after-treatment, an additional drying step is necessary.

The invention is illustrated by the following non-limitative examples.

### EXAMPLE 1

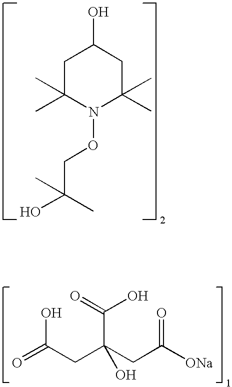

4-Hydroxy-1-(2-hydroxy-2-methylpropoxy)-2,2,6,6-tetramethylpiperidine (5 g, 0.02 mole), citric acid (4.29 g, 0.02 mole), water (50 g, 2.8 mole), sodium hydroxide (0.8 g, 0.02 mole) and methanol (400 g, 12.5 mole) are added to a round bottom flask. The mixture is heated to 50 C and stirred for 60 minutes to ensure complete dissolution. The methanol and water are removed by distillation and the resulting solid product is dried to constant weight. The title compound is obtained (8.3 g, 83% yield) as a white solid with a melting point of 123-131 C whose structure is consistent with HNMR. The HNMR spectrum indicates a ratio of about two to one.

¹H NMR (CD₃OD): δ 3.88 (t, 1H), 3.63 (s, 2H), 2.80 (s, 4H), 1.75 (d, 2H), 1.42 (t, 2H), 1.23 (s, 6H), 1.21 (s, 6H), 1.20 (s, 6H).

### EXAMPLE 2

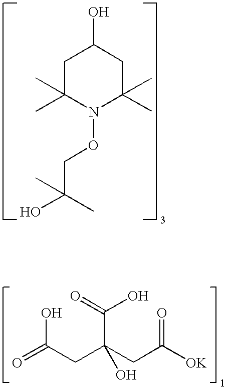

4-Hydroxy-1-(2-hydroxy-2-methylpropoxy)-2,2,6,6-tetramethylpiperidine (5 g, 0.02 mole), citric acid (4.29 g, 0.02 mole), water (50 g, 2.8 mole), potassium hydroxide (1.33 g, 0.02 mole) and methanol (400 g, 12.5 mole) are added to a round bottom flask. The mixture is heated to 50 C and stirred for 60 minutes to ensure complete dissolution. The methanol and water are removed by distillation and the resulting solid product is dried to constant weight. The title compound is obtained (8.4 g, 82% yield) as a white solid with a melting point of 124-132 C whose structure is consistent with HNMR. The HNMR spectrum indicates a ratio of about three to one.

¹H NMR (CD₃OD): δ 3.88 (t, 1H), 3.63 (s, 2H), 2.79 (q, 4H), 1.75 (d, 2H), 1.42 (t, 2H), 1.23 (s, 6H), 1.21 (s, 6H), 1.20 (s, 6H).

### EXAMPLE 3

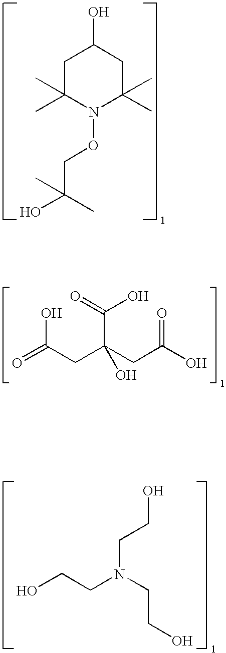

4-Hydroxy-1-(2-hydroxy-2-methylpropoxy)-2,2,6,6-tetramethylpiperidine (5 g, 0.02 mole), citric acid (4.29 g, 0.02 mole), triethanolamine (3.1 g, 0.02 mole), and methanol (100 g, 3.2 mole) are added to a round bottom flask. The mixture is stirred at ambient temperature for 30 minutes to ensure complete dissolution. The methanol is removed by distillation and the resulting solid product is dried to constant weight. The title compound is obtained (9.8 g, 80% yield) as a white, waxy solid with a melting point of 133-136 C whose structure is consistent with HNMR. The HNMR spectrum indicates a ratio of about one to one to one.

¹H NMR (CD₃OD): δ 3.89 (t, 6H), 3.88 (t, 1H), 3.63 (s, 2H), 3.41 (t, 6H), 2.77 (q, 4H), 1.75 (d, 2H), 1.42 (t, 2H), 1.23 (s, 6H), 1.21 (s, 6H), 1.20 (s, 6H).

Anal. Calcd for C₂₅H₅₀N₂O₁₃: C, 51.18; H, 8.59; N, 4.77.

Found: C, 51.48; H, 8.76; N, 4.61.

### EXAMPLE 4

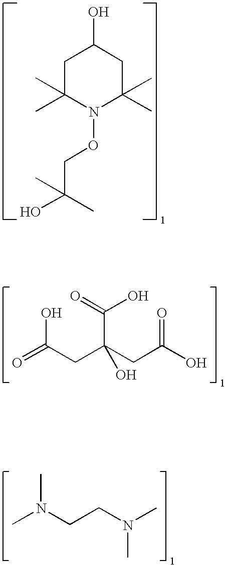

4-Hydroxy-1-(2-hydroxy-2-methylpropoxy)-2,2,6,6-tetramethylpiperidine (5 g, 0.02 mole), citric acid (4.29 g, 0.02 mole), N,N,N′,N′-tetramethylethylenediamine (2.37 g, 0.02 mole), and methanol (100 g, 3.2 mole) are added to a round bottom flask. The mixture is stirred at ambient temperature for 30 minutes to ensure complete dissolution. The methanol is removed by distillation and the resulting solid product is dried to constant weight. The title compound is obtained (10.2 g, 88% yield) as a white solid with a melting point of 110-129 C whose structure is consistent with HNMR. The HNMR spectrum indicates a ratio of about one to one to one.

¹H NMR (CD₃OD): δ 3.88 (t, 1H), 3.63 (s, 2H), 3.05 (s, 4H), 2.75 (q, 4H), 2.65 (s, 12H), 1.75 (d, 2H), 1.42 (t, 2H), 1.23 (s, 6H), 1.21 (s, 6H), 1.20 (s, 6H).

Anal. Calcd for C₂₅H₅₁N₃O₁₀: C, 54.23; H, 9.28; N, 7.59.

Found: C, 53.61; H, 9.28; N, 7.09.

### EXAMPLE 5

A resin-coated paper impregnated with inorganic adsorbent particles (Konica QP Photoglossy ink jet paper, Konica Corp.) is purchased. On the ink-receiving layer, a 0.8 wt % methanol solution of the instant compounds is applied in an amount to achieve 650-700 mg/m². The paper is allowed to dry under ambient temperature and pressure for 24 hours.

Separately, test patterns (magenta) are printed on the treated sheets using a Hewlett Packard DeskJet 970 Cxi printer at 100% print density. The obtained prints are left to dry at ambient temperature and pressure for 24 hours.

Color densities and CIEL*a*b coordinates before and after exposure are measured using X-Rite 938 Spectrodensitometer. Exposures are carried out using normal office fluorescent lighting. The change in color is given by Delta E (DE) which is calculated by:
DE=[(DL*)²+(Da*)²+(Db*)²]^{1/2}

| | DE for magenta after |
|---|---|
| Stabilizer | 4 weeks |
| None | 25.73 |
| Instant Example 3 | 24.66 |
| Instant Example 2 | 20.89 |
| Instant Example 4 | 19.43 |
| Instant Example 1 | 18.39 |

As the above data show, compounds according to this invention are able to improve clearly the light fastness of ink jet prints.

### EXAMPLE 6

A resin-coated paper impregnated with inorganic adsorbent particles (Konica QP Photoglossy ink jet paper, Konica Corp.) is purchased. On the ink-receiving layer, a 0.8 wt % methanol solution of the instant compounds is applied in an amount to achieve 650-700 mg/m². The paper is allowed to dry under ambient temperature and pressure for 24 hours. Separately, test patterns (cyan, magenta and yellow) are printed on the treated sheets using a Hewlett Packard DeskJet 970 Cxi printer at 50% print density. The obtained prints are left to dry at ambient temperature and pressure for 24 hours.

Color densities and CIEL*a*b coordinates before and after exposure are measured using X-Rite 938 Spectrodensitometer. Exposures are carried out using normal office fluorescent lighting.

| | DE for cyan after |
|---|---|
| Stabilizer | 4 weeks |
| None | 7.29 |
| Instant Example 2 | 6.64 |
| Instant Example 3 | 6.40 |
| Instant Example 4 | 4.58 |

| | DE for magenta after |
|---|---|
| Stabilizer | 4 weeks |
| None | 20.16 |
| Instant Example 3 | 18.37 |
| Instant Example 1 | 17.82 |
| Instant Example 2 | 16.71 |
| Instant Example 4 | 14.01 |

| | DE for yellow after |
|---|---|
| Stabilizer | 4 weeks |
| None | 4.68 |
| Instant Example 3 | 2.51 |
| Instant Example 2 | 2.48 |
| Instant Example 4 | 2.08 |
| Instant Example 1 | 1.81 |

As the above data show, compounds according to this invention are able to improve clearly the light fastness of ink jet prints.

### EXAMPLE 7

A resin-coated paper impregnated with inorganic adsorbent particles (Konica QP Photoglossy ink jet paper, Konica Corp.) is purchased. On the ink-receiving layer, a 0.8 wt % methanol solution of the instant compounds and Ciba Fast H, a benzotriazole based uv absorber, is applied in an amount to achieve 650-700 mg/m². The uv absorber and the instant compounds are in a 2:1 ratio by weight. The paper is allowed to dry under ambient temperature and pressure for 24 hours. Separately, test patterns (cyan, magenta and yellow) are printed on the treated sheets using an Epson printer at 100% print density. The obtained prints are left to dry at ambient temperature and pressure for 24 hours. Color densities and CIEL*a*b coordinates before and after exposure are measured using X-Rite 938 Spectrodensitometer. Exposures are carried out using normal office fluorescent lighting. The compounds according to this invention are able to improve clearly the light fastness of ink jet prints.

### EXAMPLE 8

A resin-coated paper impregnated with inorganic adsorbent particles (Konica QP Photoglossy ink jet paper, Konica Corp.) is purchased. On the ink-receiving layer, a 0.8 wt % methanol solution of the instant compounds and Tinuvin 1130, a benzotriazole based uv absorber, is applied in an amount to achieve 650-700 mg/m². The uv absorber and the instant compounds are in a 1:1 ratio by weight. The paper is allowed to dry under ambient temperature and pressure for 24 hours. Separately, test patterns (cyan, magenta and yellow) are printed on the treated sheets using a Hewlett Packard DeskJet 970 Cxi printer at 50% print density. The obtained prints are left to dry at ambient temperature and pressure for 24 hours. Color densities and CIEL*a*b coordinates before and after exposure are measured using X-Rite 938 Spectrodensitometer. Exposures are carried out using uv lamps. The compounds according to this invention are able to improve clearly the light fastness of ink jet prints.

### EXAMPLE 9

A resin-coated paper impregnated with inorganic adsorbent particles (Konica QP Photoglossy ink jet paper, Konica Corp.) is purchased. On the ink-receiving layer, a 0.8 wt % methanol solution of the instant compounds and Ciba Fast H, a benzotriazole based uv absorber, is applied in an amount to achieve 650-700 mg/m². The uv absorber and the instant compounds are in a 1:1 ratio by weight. The paper is allowed to dry under ambient temperature and pressure for 24 hours. Separately, test patterns (cyan, magenta and yellow) are printed on the treated sheets using a Hewlett Packard DeskJet 970 Cxi printer at 100% print density. The obtained prints are left to dry at ambient temperature and pressure for 24 hours. Color densities and CIEL*a*b coordinates before and after exposure are measured using X-Rite 938 Spectrodensitometer. Exposures are carried out using normal office fluorescent lighting. The compounds according to this invention are able to improve clearly the light fastness of ink jet prints.

### EXAMPLE 10

A paper sheet containing silica is prepared according to U.S. Pat. No. 5,165,973. A methanol solution of the instant compounds is applied to this sheet in an amount equivalent to 700 mg/m2. The image printed on this receiving layer shows reduced dye fading and better image permanence.

### EXAMPLE 11

The instant compounds are added to an ink composition, for example as disclosed in U.S. Pat. Nos. 5,855,655 or 5,782,963, at a concentration of 2 wt % and 0.5 wt % respectively. The images printed from these stabilized inks show reduced dye fading and better image permanence.

### EXAMPLE 12

A commercial white polyethylene terephthalate sheet is coated with silica and polyvinylalcohol according to EP 1031431 A2 Example 1. A methanol solution of the instant compounds is applied to this sheet in an amount equivalent to 400 mg/m². The image printed on this receiving layer shows reduced dye fading and better image permanence.

### EXAMPLE 13

A commercial white polyethylene terephthalate sheet is coated with alumina hydrate and polyvinylalcohol according to EP 1031431 A2 Example 5. A methanol solution of the instant compounds is applied to this sheet in an amount equivalent to 400 mg/m². The image printed on this receiving layer shows reduced dye fading and better image permanence.

### EXAMPLE 14

A paper sheet containing alumina is prepared according to EP1031431 A2 Example 8. A methanol solution of the instant compounds is applied to this sheet in an amount equivalent to 600 mg/m². The image printed on this receiving layer shows reduced dye fading and better image permanence.

### EXAMPLE 15

An ink-jet ink is prepared by dissolving 2 g of dye in 20 g of diethylene glycol and 78 g of deionized water. The dye used is Acid red 52. The instant stabilizer is weighed in an amount of 0.15 g into a test tube and dissolved in 2.85 g of ink. The obtained ink is filtered and transferred into an emptied and carefully cleaned cartridge of a Deskjet 510 printer (Hewlett-Packard). A stepped image is then printed onto plain paper (sihl+eika). The produced print is left to dry at 50° C. under vacuum for two hours and thereafter irradiated behind a 5 mm thick window glass in an Atlas Ci-35 light fading device equipped with a Xenon lamp. The Atlas device is operated at 43° C., 50% RH without dark cycles and the light intensity is 461 W/m² (300-800 nm). The color density of each step is measured before and after exposure using a MacBeth TR 924 densitometer.

The instant compounds according to this invention are able to improve substantially the light fastness of the ink-jet print.

### EXAMPLE 16

Magenta and Yellow inks are extracted from an Hewlett-Packard three-color cartridge (HP C1823D). The instant stabilizer is weighed in an amount of 0.15 g into a test tube and dissolved in 2.85 g of either the magenta or yellow ink. The obtained ink is filtered and transferred into an emptied and carefully cleaned cartridge of a Deskjet 510 printer (Hewlett-Packard). A stepped image is then printed onto plain paper (sihl+eika) or, alternatively, onto Premium Photo paper from Hewlett-Packard (item code C6040A). The produced print is left to dry at 50° C. under vacuum for two hours and thereafter irradiated behind a 5 mm thick window glass in an Atlas Ci-35 light fading device equipped with a Xenon lamp. The Atlas device is operated at 43° C., 50% RH without dark cycles and the light intensity is 461 W/m² (300-800 nm). The color density of each step is measured before and after exposure using a MacBeth TR 924 densitometer.

The instant compounds according to this invention are able to improve clearly the light fastness of the magenta and yellow prints.

### EXAMPLE 17

Canon PR-101 sheets (Canon Japan) are post-treated by casting instant stabilizer solutions, either aqueous or methanol, using a 75 micron wire wound coating bar. After drying at room temperature, the thus modified sheets are printed with cyan step images using a Canon BJC 8200 printer. The cyan dye used is C.I. Direct Blue 199. The obtained prints are left to dry at 50 C under vacuum for two hours and thereafter are subjected to forced airflow during four weeks. The color density is measured before and after exposure using a MacBeth TR 924 densitometer.

The instant compounds according to this invention are able to improve clearly the light fastness of cyan prints.

### EXAMPLE 18

Canon PR-101 sheets (Canon Japan) are post-treated by casting instant stabilizer solutions, either aqueous or methanol, using a 75 micron wire wound coating bar. After drying at room temperature, the thus modified sheets are printed with cyan step images using a Canon BJC 8200 printer. The cyan dye used is C.I. Direct Blue 199. The obtained prints are left to dry at 50 C under vacuum for two hours. Samples are irradiated behind a 5 mm thick window glass in an Atlas Ci-35 light fading device equipped with a 3500 W Xenon lamp. The Atlas device is operated at 43° C. 50% RH without dark cycles. The CIEL*a*b coordinates of each step are measured before and after exposure using a Datacolor Elrepho 2000 densitometer.

The instant compounds according to this invention are able to improve clearly the light fastness of the cyan prints.

### EXAMPLE 19

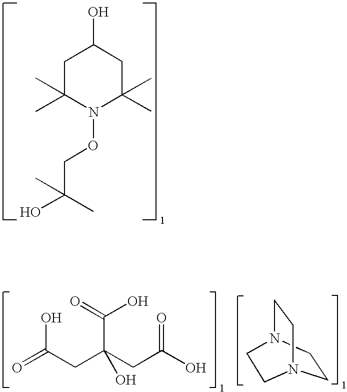

4-Hydroxy-1-(2-hydroxy-2-methylpropoxy)-2,2,6,6-tetramethylpiperidine (5 g, 0.02 mole), citric acid (4.29 g, 0.02 mole), 1,4-diazabicyclo[2.2.2]octane (2.24 g, 0.02 mole), and methanol (200 g, 6.4 mole) are added to a round bottom flask. The mixture is stirred at ambient temperature for 30 minutes to ensure complete dissolution. The methanol is removed by distillation and the resulting solid product is dried to constant weight. The title compound is obtained (9.8 g, 85% yield) as a white, crystalline solid with a melting point of 132-135 C whose structure is consistent with HNMR. The HNMR spectrum indicates a ratio of about one to one to one.

¹H NMR (CD₃OD): δ 3.88 (t, 1H), 3.63 (s, 2H), 3.18 (s, 12H), 3.05 (s, 4H), 2.75 (q, 4H), 2.65 (s, 12H), 1.75 (d, 2H), 1.42 (t, 2H), 1.23 (s, 6H), 1.21 (s, 6H), 1.20 (s, 6H).

What is claimed is:

1. An ink-jet system comprising a recording material and at least one colored ink to be applied to the recording material by means of an ink-jet nozzle wherein the recording material or the at least one colored ink contains at least one water soluble hindered amine of the formula (I) 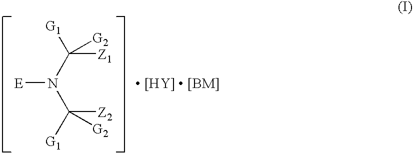
wherein
G₁ and G₂ are independently alkyl of 1 to 4 carbon atoms or are together pentamethylene; Z₁ and Z₂ are each methyl, or Z₁ and Z₂ together form an unsubstituted linking moiety or a linking moiety substituted by one or more groups selected from an ester, ether, hydroxy, oxo, cyanohydrin, amide, amino, carboxy or an urethane group;
E is alkoxy of 1 to 18 carbon atoms, cycloalkoxy of 5 to 12 carbon atoms or aralkoxy of 7 to 15 carbon atoms, or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
HY is an inorganic or organic acid; and, wherein the total charge of cations is equal to the total charge of anions; and
BM is a basic material selected from the group consisting of alkali metal hydroxides, alkaline earth metal hydroxides, and amines.

2. An ink-jet recording material according to claim 1 comprising at least one water soluble hindered amine of the formula (I).

3. An ink-jet ink according to claim 1 comprising at least one water soluble hindered amine of the formula (I).

4. An ink-jet system according to claim 1 wherein Z₁ and Z₂ as a linking moiety are a chain of 2 or 3 carbon atoms or 1 or 2 carbon atoms and a nitrogen or oxygen atom forming together with the remaining structure in formula (I) a saturated unsubstituted 5- or 6-membered heterocyclic ring or a 5- or 6-membered heterocyclic ring substituted by one or more groups selected from the group consisting of ester, ether, hydroxy, oxo, cyanohydrin, amide, amino, carboxy, and urethane.

5. An inkjet system according to claim 1 wherein Y in formula (I) is selected from the group consisting of phosphate, phosphonate, carbonate, bicarbonate, nitrate, chloride, bromide, bisulfite, sulfite, bisulfate, sulfate, borate, formate, acetate, benzoate, citrate, oxalate, tartrate, acrylate, polyacrylate, fumarate, maleate, itaconate, glycolate, gluconate, malate, mandelate, tiglate, ascorbate, polymethacrylate, a carboxylate of nitrilotriacetic acid, a carboxlylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, and alkyl-substituted arylsulfonate.

6. An ink-jet system according to claim 1 wherein the compounds of formula (I) are selected from the group consisting of formulae (A*) to (EE*) and (III) to (IIIc) 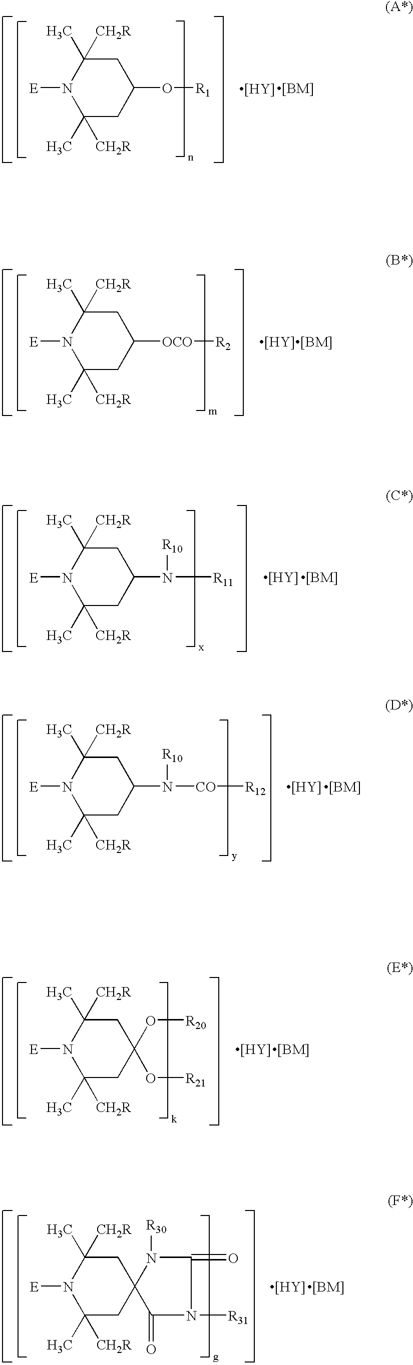 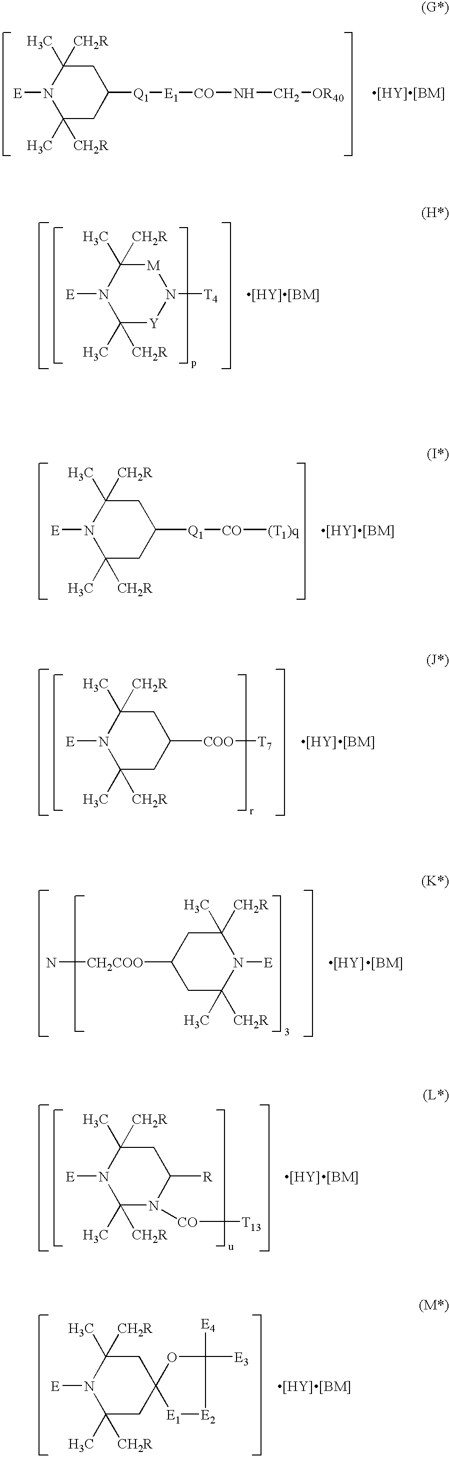 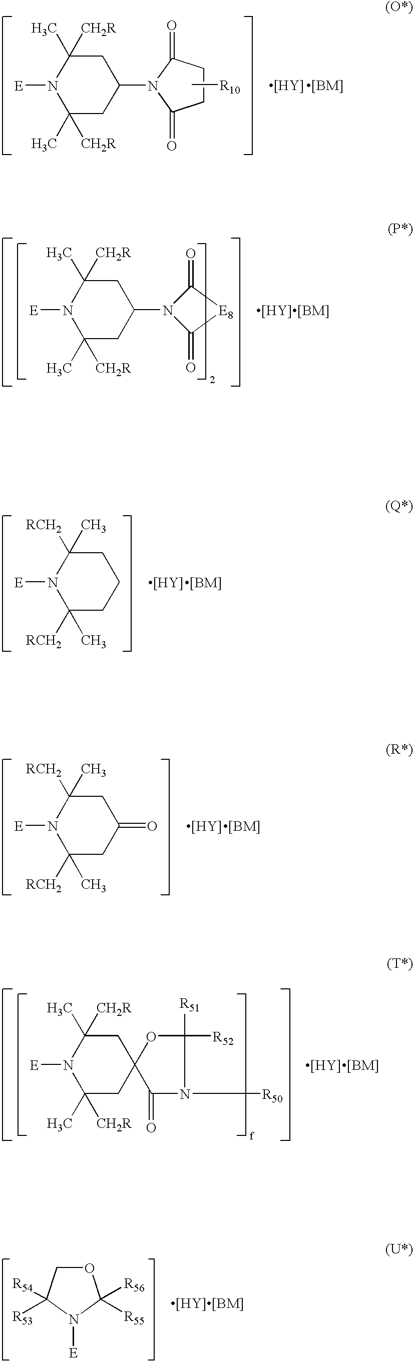 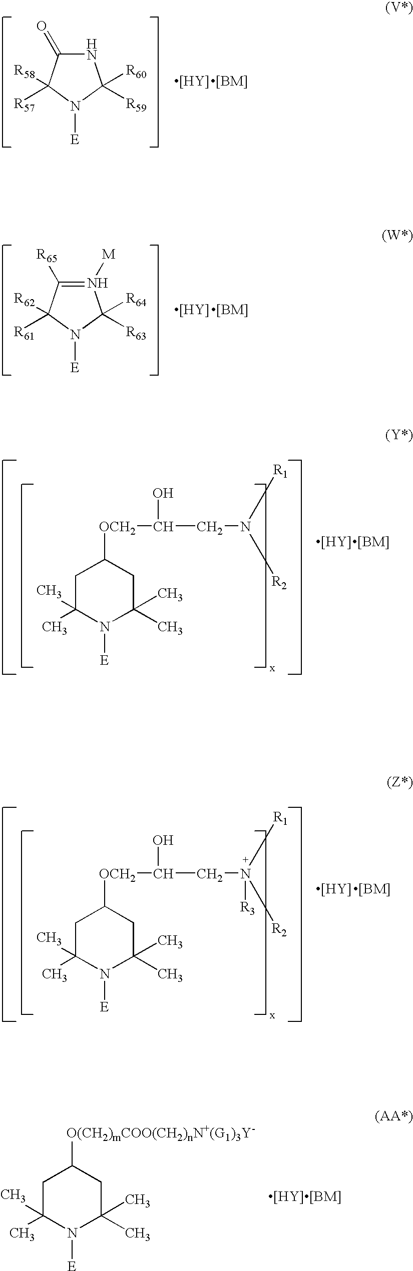 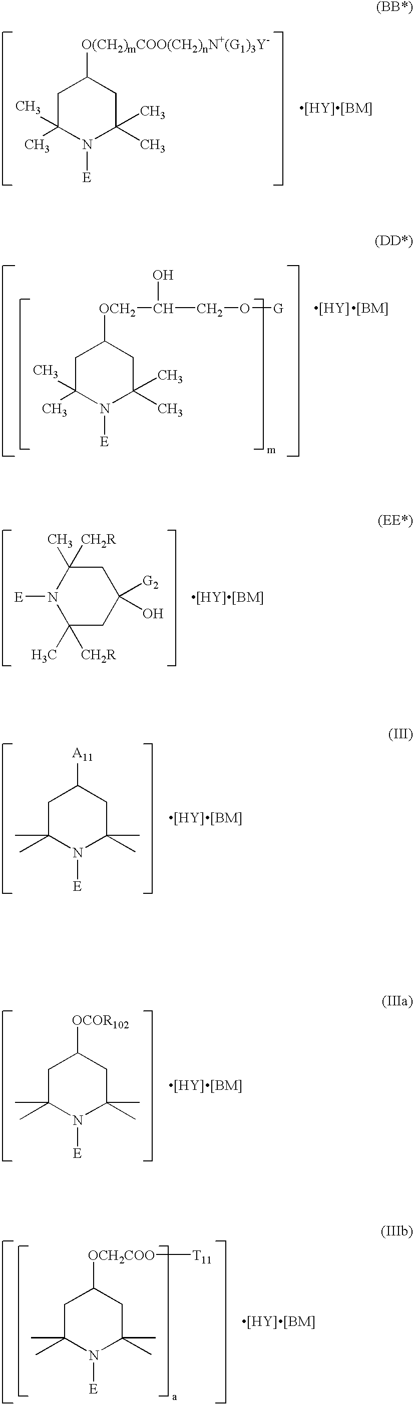 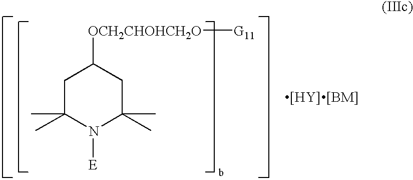
wherein
E is alkoxy of 1 to 18 carbon atoms, cycloalkoxy of 5 to 12 carbon atoms or aralkoxy of 7 to 15 carbon atoms, or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen or methyl; and
in formula (A*) n is 1 or 2,
when n is 1,
R₁ is hydrogen, alkyl of 1 to 18 carbon atoms, alkenyl of 2-18 carbon atoms, propargyl, glycidyl, alkyl of 2 to 50 carbon atoms interrupted by one to twenty oxygen atoms, said alkyl substituted by one to ten hydroxyl groups or both interrupted by said oxygen atoms and substituted by said hydroxyl groups, or
R₁ is alkyl of 1 to 4 carbon atoms substituted by a carboxy group or by —COOZ where Z is hydrogen, alkyl of 1 to 4 carbon atoms or phenyl, or where Z is said alkyl substituted by —(COO⁻)ₙMⁿ⁺ where n is 1-3 and M is a metal ion from the 1 st, 2nd or 3rd group of the periodic table or is Zn, Cu, Ni or Co, or M is a group Nⁿ⁺(R₂)₄ where R₂ is alkyl of 1 to 8 carbon atoms or benzyl,
when n is 2,
R₁ is alkylene of 1 to 12 carbon atoms, alkenylene of 4 to 12 carbon atoms, xylylene or alkylene of 1 to 50 carbon atoms interrupted by one to twenty oxygen atoms, substituted by one to ten hydroxyl groups or both interrupted by said oxygen atoms and substituted by said hydroxyl groups;
in formula (B*), m is 1 to 4, and
when m is 1,
R₂ is alkyl of 1 to 18 carbon atoms, alkyl of 3 to 18 carbon atoms interrupted by —COO—, alkyl of 3 to 18 carbon atoms substituted by COOH or COO—, or R₂ is —CH₂(OCH₂CH₂)ₙOCH₃ where n is 1 to 12, or
R₂ is cycloalkyl of 5 to 12 carbon atoms, aryl of 6 to 12 carbon atoms, or said aryl substituted by one to four alkyl groups of 1 to 4 carbon atoms, or
R₂ is —NHR₃ where R₃ is alkyl of 1 to 18 carbon atoms, cycloalkyl of 5 to 12 carbon atoms, aryl of 6 to 12 carbon atoms, or said aryl substituted by one to four alkyl of 1 to 4 carbon atoms, or
R₂ is —N(R₃)₂ where R₃ is as defined above,
when m is 2,
R₂ is alkylene of 1 to 12 carbon atoms, alkenylene of 4 to 12 carbon atoms, xylylene, alkylene of 2 to 12 carbon atoms interrupted by —COO—, alkylene of 3 to 18 carbon atoms substituted by COOH or COO—, or R₂ is —CH₂(OCH₂CH₂)ₙOCH₂— where n is 1 to 12, or
R₂ is cycloalkylene of 5 to 12 carbon atoms, aralkylene of 7 to 15 carbon atoms or arylene of 6 to 12 carbon atoms, or
R₂ is —NHR₄NH— where R₄ is alkylene of 2 to 18 carbon atoms, cycloalkylene of 5 to 12 carbon atoms, aralkylene of 8 to 15 carbon atoms or arylene of 6 to 12 carbon atoms, or
R₂ is —N(R₃)R₄N(R₃)— where R₃ and R₄ are as defined above, or
R₂ is —CO—, —NH—CO—NH—, or —N(R3)-CO—N(R3)-,
when m is 3,
R₂ is alkanetriyl of 3 to 8 carbon atoms or benzenetriyl, or
when m is 4,
R₂ is alkanetetrayl of 5 to 8 carbon atoms or benzenetetrayl,
in formula (C*),
R₁₀ is hydrogen, alkyl of 1 to 18 carbon atoms, cycloalkyl of 5 to 12 carbon atoms, aralkyl of 7 to 15 carbon atoms, alkanoyl of 2 to 18 carbon atoms, alkenoyl of 3 to 5 carbon atoms or benzoyl,
x is 1 or 2, and
when x is 1,
R₁₁ is hydrogen, alkyl of 1 to 18 carbon atoms, alkenyl of 2 to 18 carbon atoms, propargyl, glycidyl, alkyl of 2 to 50 carbon atoms interrupted by one to twenty oxygen atoms, said alkyl substituted by one to ten hydroxyl groups or both interrupted by said oxygen atoms and substituted by said hydroxyl groups, or
R₁₁ is alkyl of 1 to 4 carbon atoms substituted by a carboxy group or by —COOZ where Z is hydrogen, alkyl of 1 to 4 carbon atoms or phenyl, or where Z is said alkyl substituted by —(COO⁻)ₙMⁿ⁺ where n is 1-3 and M is a metal ion from the 1st, 2nd or 3rd group of the periodic table or is Zn, Cu, Ni or Co, or M is a group Nⁿ⁺(R₂)₄ where R₂ is hydrogen, alkyl of 1 to 8 carbon atoms or benzyl, or
when x is 2,
R₁₁ is alkylene of 1 to 12 carbon atoms, alkenylene of 4 to 12 carbon atoms, xylylene or alkylene of 1 to 50 carbon atoms interrupted by one to twenty oxygen atoms, substituted by one to ten hydroxyl groups or both interrupted by said oxygen atoms and substituted by said hydroxyl groups,
in formula (D*), y is 1 to 4,
R₁₀ is as defined above,
and R₁₂ is defined as R₂ above,
in formula (E*), k is 1 or 2,
when k is 1,
R₂₀ and R₂₁ are independently alkyl of 1 to 12 carbon atoms, alkenyl of 2 to 12 carbon atoms or aralkyl of 7 to 15 carbon atoms, or R₂₀ is also hydrogen, or
R₂₀ and R₂₁ together are alkylene of 2 to 8 carbon atoms or said alkylene substituted by hydroxyl, or are acyloxy-alkylene of 4 to 22 carbon atoms, or
when k is 2,
R₂₀ and R₂₁, are together (—CH₂)₂C(CH₂—)₂,
in formula (F*),
R₃₀ is hydrogen, alkyl of 1 to 18 carbon atoms, benzyl, glycidyl, or alkoxyalkyl of 2 to 6 carbon atoms,
g is 1 or 2,
when g is 1, R₃₁ is defined as R₁ above when n is 1,
when g is 2, R₃₁ is defined as R₁ above when n is 2,
in formula (G*),
Q₁ is —NR₄₁— or —O—,
E₁ is alkylene of 1 to 3 carbon atoms, or E₁ is —CH₂—CH(R₄₂)—O— where R₄₂ is hydrogen, methyl or phenyl, or E₁ is —(CH₂)₃—NH— or E₁ is a direct bond,
R₄₀ is hydrogen or alkyl of 1 to 18 carbon atoms,
R₄₁ is hydrogen, alkyl of 1 to 18 carbon atoms, cycloalkyl of 5 to 12 carbon atoms, aralkyl of 7 to 15 carbon atoms, aryl of 6 to 10 carbon atoms, or R₄₁ is —CH₂—CH(R₄₂)—OH where R₄₂ is as defined above,
in formula (H*), p is 1 or 2,
T₄ is as defined for R₁₁ when x is 1 or 2,
M and Y are independently methylene or carbonyl, preferably M is methylene and Y is carbonyl,
in formula (I*),
this formula denotes a recurring structural unit of a polymer where T₁ is ethylene or 1,2-propylene or is the repeating structural unit derived from an alpha-olefin copolymer with an alkyl acrylate or methacrylate, and where
q is 2 to 100,
Q₁ is —N(R₄₁)— or —O— where R₄₁ is as defined above,
in formula (J*),
r is 1 or 2,
T₇ is as defined for R₁ when n is 1 or 2 in formula (A*),
preferably T₇ is octamethylene when r is 2,
in formula (L*), u is 1 or 2,
T₁₃ is as defined for R₁ when n is 1 or 2 in formula (A*), with the proviso that T₁₃ is not hydrogen when u is 1,
in formula (M*),
E₁ and E₂, being different, each are —CO— or —N(E₅)- where E₅ is hydrogen, alkyl of 1 to 12 carbon atoms or alkoxycarbonylalkyl of 4 to 22 carbon atoms, preferably E₁ is —CO— and E₂ is —N(E₅)-,
E₃ is hydrogen, alkyl of 1 to 30 carbon atoms, phenyl, naphthyl, said phenyl or said naphthyl substituted by chlorine or by alkyl of 1 to 4 carbon atoms, or phenylalkyl of 7 to 12 carbon atoms, or said phenylalkyl substituted by alkyl of 1 to 4 carbon atoms,
E₄ is hydrogen, alkyl of 1 to 30 carbon atoms, phenyl, naphthyl or phenylalkyl of 7 to 12 carbon atoms, or
E₃ and E₄ together are polymethylene of 4 to 17 carbon atoms, or said polymethylene substituted by one to four alkyl of 1 to 4 carbon atoms, preferably methyl,
in formula (O*),
R₁₀ is as defined for R₁₀ in formula (C*),
in formula (P*),
E₆ is an aliphatic or aromatic tetravalent radical, preferably neopentanetetrayl or benzenetetrayl,
in formula (T*),
R₅₁ is hydrogen, alkyl of 1 to 18 carbon atoms, cycloalkyl of 5 to 12 carbon atoms, or aryl of 6 to 10 carbon atoms,
R₅₂ is hydrogen or alkyl of 1 to 18 carbon atoms, or
R₅₁ and R₅₂ together of alkylene of 4 to 8 carbon atoms,
f is 1 or 2,
when f is 1,
R₅₀ is as defined for R₁₁ in formula (C*) when x is 1, or R₅₀ is —(CH₂)ₙCOOR₅₄ where z is 1 to 4 and R₅₄ is hydrogen or alkyl of 1 to 18 carbon atoms, or R₅₄ is a metal ion from the 1st, 2nd or 3rd group of the periodic table or a group —N(R₅₅)₄ where R₅₅ is hydrogen, alkyl of 1 to 12 carbon atoms or benzyl,
when f is 2,
R₅₀ is as defined for R₁₁ in formula (C*) when x is 2,
in formula (U*),
R₅₃, R₅₄, R₅₅ and R₅₆ are independently alkyl of 1 to 4 carbon atoms or are together pentamethylene,
in formula (V*),
R₅₇, R₅₈, R₅₉ and R₆₀ are independently alkyl of 1 to 4 carbon atoms or are together pentamethylene,
in formula (W*),
R₆₁, R₆₂, R₆₃ and R₆₄ are independently alkyl of 1 to 4 carbon atoms or are together pentamethylene,
R₆₅ is alkyl of 1 to 5 carbon atoms,
M is hydrogen or oxygen,
wherein in formulas (Y*) to (BB*),
n is 2 to 3,
G₁ is hydrogen, methyl, ethyl, butyl or benzyl,
m is 1 to 4,
x is 1 to 4,
when x is 1, R₁ and R₂ are independently alkyl of 1 to 18 carbon atoms, said alkyl interrupted by one to five oxygen atoms, said alkyl substituted by 1 to 5 hydroxyl groups or said alkyl both interrupted by said oxygen atoms and substituted by said hydroxyl groups; cycloalkyl of 5 to 12 carbon atoms, aralkyl of 7 to 15 carbon atoms, aryl of 6 to 10 carbon atoms or said aryl substituted by one to three alkyl of 1 to 8 carbon atoms, or R₁ is also hydrogen, or R₁ and R₂ are together tetramethylene, pentamethylene, hexamethylene or 3-oxapentamethylene,
when x is 2,
R₁ is hydrogen, alkyl of 1 to 8 carbon atoms, said alkyl interrupted by one or two oxygen atoms, said alkyl substituted by a hydroxyl group, or said alkyl both interrupted by one or two oxygen atoms and substituted by a hydroxyl group,
R₂ is alkylene of 2 to 18 carbon atoms, said alkylene interrupted by one to five oxygen atoms, said alkylene substituted by 1 to 5 hydroxyl groups or said alkylene both interrupted by said oxygen atoms and substituted by said hydroxyl groups; o-, m- or p-phenylene or said phenylene substituted by one or two alkyl of 1 to 4 carbon atoms, or
R₂ is —(CH₂)ₖO[(CH₂)ₖO]ₕ(CH₂)ₖ— where k is 2 to 4 and h is 1 to 40, or
R₂ and R₂ together with the two N atoms to which they are attached are piperazin-1,4-diyl,
when x is 3,
R₁ is hydrogen,
R₂ is alkylene of 4 to 8 carbon atoms interrupted by one nitrogen atom,
when x is 4,
R₁ is hydrogen,
R₂ is alkylene of 6 to 12 carbon atoms interrupted by two nitrogen atoms,
R₃ is hydrogen, alkyl of 1 to 8 carbon atoms, said alkyl interrupted by one or two oxygen atoms, said alkyl substituted by a hydroxyl group, or both interrupted by one or two oxygen atoms and substituted by a hydroxyl group,
p is 2 or 3,
in formula (DD*),
m is 2 or 3,
when m is 2,
G is —(CH₂CHR—O)ᵣCH₂CHR—, where r is 0 to 3, and R is hydrogen or methyl, and
when m is 3, G is glyceryl,
in formula (EE*),
G₂ is —CN, —CONH₂ or —COOG₃ where G₃ is hydrogen, alkyl of 1 to 18 carbon atoms or phenyl,
in formulae (III) to (IIIc)
A11 is OR₁₀₁ or NR₁₁₁R₁₁₂
R₁₀₁ is alkenyl of 2 to 4 carbon atoms, propargyl, glycidyl, alkyl of 2 to 6 carbon atoms interrupted by one or two oxygen atoms, substituted by one to three hydroxyl groups or both interrupted by said oxygen atoms and substituted by said hydroxyl groups, or R₁₀₁ is alkyl of 1 to 4 carbon atoms substituted by carboxy or by the alkali metal, ammonium or C₁-C₄alkylammonium salts thereof; or R₁₀₁ is alkyl substituted by COOE₁₀ where E₁₀ is methyl or ethyl,
R₁₀₂ is alkyl of 3 to 5 carbon atoms interrupted by —COO— or by —CO—, or R₁₀₂ is —CH₂(OCH₂CH₂)_{c}COCH₃ where c is 1 to 4; or
R₁₀₂ is —NHR₁₀₃ where R₁₀₃ is alkyl of 1 to 4 carbon atoms,
a is 2 to 4,
when a is 2,
T₁₁ is —(CH₂CHR₁₀₀—O)_{d}CH₂CHR₁₀₀—, where d is 0 or 1, and R₁₀₀ is hydrogen or methyl,
when a is 3, T₁₁ is glyceryl,
when a is 4, T₁₁ is neopentanetetrayl,
b is 2 or 3,
when b is 2,
G₁₁ is —(CH₂CHR₁₀₀—O)_{d}CH₂CHR₁₀₀—, where d is 0 or 1, and R₁₀₀ is hydrogen or methyl, and
when b is 3, G₁, is glyceryl;
R₁₁₁ is hydrogen, unsubstituted alkyl of 1 to 4 carbon atoms, alkyl of 1 to 4 carbon atoms substituted by one or two hydroxyl, alkyl of 1 to 4 carbon atoms interrupted by one or two oxygen atoms, or both substituted by one hydroxyl and interrupted by one or two oxygen atoms,
R₁₁₂ is —CO—R₁₁₃ where R₁₁₃ has the same meaning as R₁₁₁, or R₁₁₃ is NHR₁₁₄, wherein R₁₁₄ is unsubstituted alkyl of 1 to 4 carbon atoms, alkyl of 1 to 4 carbon atoms substituted by one or two hydroxyl, alkyl of 1 to 4 carbon atoms substituted by alkoxy of 1 to 2 carbon atoms, or both substituted by one hydroxyl and by alkoxy of 1 to 2 carbon atoms, or
R₁₁₁ and R₁₁₂ together are —CO—CH₂CH₂—CO—, or (CH₂)₆CO—;
BM is a basic material selected from the group consisting of alkali metal hydroxides, alkaline earth metal hydroxides, and amines;
amines are R₁₁₅—N(R₁₁₆)—R₁₁₇, wherein
R₁₁₅, R₁₁₆, and R₁₁₇ are independently hydrogen, straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or said alkyl substituted by one or more —OH, —OCO—R₁₁₈, —OR₁₁₉, or —NH₂ groups or mixtures thereof; or said alkyl or said alkenyl interrupted by one or more —O—, —NH— or —NR₁₁₉— groups or mixtures thereof and which can be unsubstituted or substituted by one or more —OH, —OR₁₁₉ or —NH₂ groups or mixtures thereof;
R₁₁₈ is hydrogen, straight or branched chain C₁-C₁₈alkyl, C₅-C₁₂cycloalkyl, straight or branched chain C₃-C₈alkenyl, C₆-C₁₄aryl or C₇-C₁₅aralkyl,
R₁₁₉ is straight or branched chain alkyl of 1 to 18 carbon atoms;
alkali metal hydroxide is sodium hydroxide, potassium hydroxide, or rubidium hydroxide;
alkaline earth metal hydroxide is magnesium hydroxide, calcium hydroxide, strontium hydroxide, or barium hydroxide;
HY is an inorganic or organic acid; wherein the total charge of cations is equal to the total charge of anions; and
Y is phosphate, phosphonate, carbonate, bicarbonate, nitrate, chloride, bromide, bisulfite, sulfite, bisulfate, sulfate, borate, formate, acetate, benzoate, citrate, oxalate, tartrate, acrylate, polyacrylate, fumarate, maleate, itaconate, glycolate, gluconate, malate, mandelate, tiglate, ascorbate, polymethacrylate, a carboxylate of nitrilotriacetic acid, a carboxlylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

7. An ink-jet system according to claim 6 wherein the compounds of formula (I) are selected from the group consisting of (A*), (B*), (C*), (D*), (Q*), (R*), (Y*), and (Z*),
wherein
E is alkoxy of 1 to 10 carbon atoms, cycloalkoxy of 5 to 8 carbon atoms or aralkoxy of 7 to 12 carbon atoms, or E is —O-T-(OH)_{b},
T is a straight or branched chain alkylene of 1 to 10 carbon atoms, cycloalkylene of 5 to 10 carbon atoms, cycloalkenylene of 5 to 10 carbon atoms, a straight or branched chain
alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen;
in formula (A*), n is 1 or 2,
when n is 1,
R₁ is hydrogen, alkyl of 1 to 6 carbon atoms, alkenyl of 2-6 carbon atoms, propargyl, glycidyl, alkyl of 2 to 20 carbon atoms interrupted by one to ten oxygen atoms, said alkyl substituted by one to five hydroxyl groups or both interrupted by said oxygen atoms and substituted by said hydroxyl groups, or
R₁ is alkyl of 1 to 4 carbon atoms substituted by a carboxy group or by —COOZ where Z is hydrogen or alkyl of 1 to 4 carbon atoms,
when n is 2,
R₁ is alkylene of 1 to 8 carbon atoms, alkenylene of 4 to 8 carbon atoms, alkylene of 1 to 20 carbon atoms interrupted by one to ten oxygen atoms, substituted by one to five hydroxyl groups or both interrupted by said oxygen atoms and substituted by said hydroxyl groups,
in formula (B*), m is 1 or 2
when m is 1,
R₂ is alkyl of 1 to 4 carbon atoms or R₂ is CH₂(OCH₂CH₂)ₙOCH₃ where n is 1 to 12, or
R₂ is phenyl, or said phenyl substituted by one to three methyl groups, or
R₂ is —NHR₃ where R₃ is alkyl of 1 to 4 carbon atoms or phenyl, or said phenyl substituted by one or two methyl groups,
when m is 2,
R₂ is alkylene of 1 to 8 carbon atoms, alkenylene of 4 to 8 carbon atoms, or R₂ is —CH₂(OCH₂CH₂)ₙOCH₂— where n is 1 to 12, or
R₂ is —NHR₄NH— where R₄ is of 2 to 6 carbon atoms, aralkylene of 8 to 15 carbon atoms or arylene of 6 to 12 carbon atoms, or
R₂ is —CO— or —NHCONH—,
in formula (C*),
R₁₀ is hydrogen or, alkanoyl of 1 to 3 carbon atoms,
x is 1 or 2,
when x is 1,
R₁₁ is hydrogen, alkyl of 1 to 6 carbon atoms or glycidyl, or
R₁₁ is alkyl of 1 to 4 carbon atoms substituted by a carboxy group or by COOZ where Z is hydrogen or alkyl of 1 to 4 carbon atoms,
when x is 2,
R₁₁ is alkylene of 1 to 6 carbon atoms,
in formula (D*),
R₁₀ is hydrogen,
y is 1 or 2,
R₁₂ is defined as R₂ above,
in formula (Y*) and (Z*),
x is 1 or 2,
when x is 1,
R₁ and R₂ are independently alkyl of 1 to 4 carbon atoms or R₁ and R₂ are together tetramethylene, or pentamethylene,
R₂ is hydrogen or alkyl of 1 to 4 carbon atoms, said alkyl group substituted by a hydroxyl group,
when x is 2,
R₁ is hydrogen, alkyl of 1 to 4 carbon atoms, said alkyl substituted by a hydroxyl group,
R₂ is alkylene of 2 to 6 carbon atoms,
R₃ is as defined above,
BM is a basic material selected from the group consisting of alkali metal hydroxides, alkaline earth metal hydroxides, and amines;
amines are R₁₁₅—N(R₁₁₆)—R₁₁₇, wherein
R₁₁₅, R₁₁₆, and R₁₁₇ are independently hydrogen, straight or branched alkyl chain of 1 to 18 carbon atoms, straight or branched chain alkenyl of 2 to 12 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or said alkyl substituted by one or more —OH, —OR₁₁₉, or —NH₂ groups or mixtures thereof; or said alkyl or said alkenyl interrupted by one or more —O—, —NH— or —NR₁₁₉— groups or mixtures thereof and which can be unsubstituted or substituted by one or more —OH, —OR₁₁₉ or —NH₂ groups or mixtures thereof;
alkali metal hydroxide is sodium hydroxide or potassium hydroxide;
alkaline earth metal hydroxide is magnesium hydroxide and calcium hydroxide;
HY is an inorganic or organic acid; and, wherein the total charge of cations is equal to the total charge of anions; and
Y is phosphate, phosphonate, carbonate, bicarbonate, chloride, bromide, bisulfate, sulfate, borate, formate, acetate, benzoate, citrate, oxalate, tartrate, acrylate, fumarate, maleate, itaconate, glycolate, gluconate, malate, mandelate, tiglate, ascorbate, a carboxylate of nitrilotriacetic acid, a carboxylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

8. An ink-jet system according to claim 7 wherein the compounds of formula (I) are selected from the group consisting of (A*), (B*), (C*), (D*), (Q*), and (R*),
wherein
E is alkoxy of 1 to 10 carbon atoms, cycloalkoxy of 5 to 8 carbon atoms or aralkoxy of 7 to 12 carbon atoms, or E is —O-T-(OH)_{b},
T is a straight or branched chain alkylene of 1 to 10 carbon atoms, cycloalkylene of 5 to 10 carbon atoms, cycloalkenylene of 5 to 10 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and
when b is 2 or 3, each hydroxyl group is attached to a different carbon atoms of T;
R is hydrogen,
in formula (A*),
h is 1,
R₁ is hydrogen, alkyl of 1 to 4 carbon atoms, glycidyl, alkyl of 2 to 4 carbon atoms interrupted by one or two oxygen atoms, said alkyl substituted by one or two hydroxyl groups or both interrupted by said oxygen atoms and substituted by said hydroxyl groups, or
R₁ is alkyl of 1 to 4 carbon atoms substituted by —COOZ where Z is hydrogen or alkyl of 1 to 4 carbon atoms,
in formula (B*),
m is 1 or 2,
R₂ is alkyl of 1 to 4 carbon atoms or R₂ is CH₂(OCH₂CH₂)ₙOCH₃ where n is 1 to 4,
when m is 2,
R₂ is alkylene of 1 to 8 carbon atoms,
in formula (C*),
R₁₀ is hydrogen or alkanoyl of 1 or 2 carbon atoms,
x is 1 or 2,
when x is 1,
R₁₁ is hydrogen, alkyl of 1 to 4 carbon atoms or glycidyl,
R₁₁ is alkyl of 1 to 4 carbon atoms substituted by COOZ where Z is hydrogen or alkyl of 1 to 4 carbon atoms,
when x is 2,
R₁₁ is alkylene of 1 to 6 carbon atoms,
in formula (D*),
R₁₀ is hydrogen,
y is 1 or 2,
R₁₂ is defined as R₂ above;
BM is a basic material selected from the group consisting of alkali metal hydroxides, alkaline earth metal hydroxides, and amines;
amines are R₁₁₅—N(R₁₁₆)—R₁₁₇, wherein
R₁₁₅, R₁₁₆, and R₁₁₇ are independently hydrogen, straight or branched alkyl chain of 1 to 12 carbon atoms, or said alkyl substituted by one or more —OH, —OR₁₁₉, or —NH₂ groups or mixtures thereof; or said alkyl interrupted by one or more —O—, —NH— or —NR₁₁₉— groups or mixtures thereof and which can be unsubstituted or substituted by one or more —OH, —OR₁₁₉ or —NH₂ groups or mixtures thereof;
R₁₁₉ is straight or branched chain alkyl of 1 to 8 carbon atoms;
alkali metal hydroxide is sodium hydroxide or potassium hydroxide;
alkaline earth metal hydroxide is calcium hydroxide;
HY is an inorganic or organic acid; and, wherein the total charge of cations is equal to the total charge of anions; and
Y is phosphate, phosphonate, carbonate, bicarbonate, chloride, bromide, bisulfate, sulfate, borate, formate, acetate, benzoate, citrate, oxalate, tartrate, ascorbate, acrylate, fumarate, maleate, itaconate, glycolate, gluconate, malate, mandelate, tiglate, a carboxylate of nitrilotriacetic acid, a carboxylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

9. An ink-jet system according to claim 1 wherein the compound of formula (I) is selected from the group consisting of
(a) Monosodium 1-methoxy-2,2,6,6-tetramethyl-4-acetoxypiperidinium citrate;
(b) Monopotassium 1-methoxy-2,2,6,6-tetramethyl-4-acetamidopiperidinium phosphate;
(c) Monoammonium 1-butoxy-2,2,6,6-tetramethyl-4-acetamidopiperidinium sulfate;
(d) Mono-(N,N, N-triethylammonium) 1-phenoxy-2,2,6,6-tetramethyl-4-methoxy-piperidinium tartrate;
(e) Mono-[N,N-di-n-butyl ammonium]1-ethoxy-2,2,6,6-tetramethyl-4-acetoxypiperidinium maleate;
(f) Mono-[N,N,N-(2-hydroxyethyl)ammonium]1-methoxy-2,2,6,6-tetramethyl-4-propoxypiperidinium oxalate;
(g) Monosodium 1-methoxy-2,2,6,6-tetramethyl-4-(2-hydroxy-4-oxapentoxy)piperidinium carbonate;
(h) Dipotassium 1-(2-hydroxy-2-methylpropoxy)-2,2,6,6-tetramethyl-4-hydroxypiperidinium citrate;
(i) Monosodium bis(1-(2-hydroxy-2-methylpropoxy)-2,2,6,6-tetramethyl-4-hydroxypiperidinium) citrate;
(j) Diammonium (1-(2-hydroxy-2-methylpropoxy)-2,2,6,6-tetramethyl-4-hydroxypiperidinium) citrate;
(k) Monopotassium monosodium bis(1-(2-hydroxy-2-methylpropoxy)-2,2,6,6-tetramethyl-4-hydroxypiperidinium)ethylenediaminetetraacetate;
(l) Monosodium tris(1-(2-hydroxy-2-methylpropoxy)-2,2,6,6-tetramethyl-4-acetamidopiperidinium)ethylenediaminetetraacetate;
(m) Monocalcium bis(1-(2-hydroxy-2-methylpropoxy)-2,2,6,6-tetramethyl-4-oxopiperidinium) ethylenediaminetetraacetate;
(n) Monoammonium tetra(1-(2-hydroxy-2-methylpropoxy)-2,2,6,6-tetramethyl-4-hydroxypiperidinium) diethylenetriaminepentaacetate;
(o) Disodium tris(1-(2-hydroxy-2-methylpropoxy)-2,2,6,6-tetramethyl-4-acetamidopiperidinium) diethylenetriaminepentaacetate;
(p) Tripotassium di(1-(2-hydroxy-2-methylpropoxy)-2,2,6,6-tetramethyl-4-oxopiperidinium) diethylenetriaminepentaacetate;
(q) Monobenzylammonium bis(1-(2-hydroxy-2-methylpropoxy)-2,2,6,6-tetramethyl-4-hydroxypiperidinium)nitrilotriacetate;
(r) Di-[N,N-diethylammonium]mono(1-(2-hydroxy-2-methylpropoxy)-2,2,6,6-tetramethyl-4-acetamidopiperidinium)nitrilotriacetate;
(s) Monosodium bis(1-(2-hydroxy-2-methylpropoxy)-2,2,6,6-tetramethyl-4-oxopiperidinium) nitrilotriacetate;
(t) Diammonium tris(1-(2-hydroxy-2-methylpropoxy)-2,2,6,6-tetramethyl-4-hydroxypiperidinium) diethylenetriaminepentamethylenephosphonate;
(u) Monosodium tetra(1-(2-hydroxy-2-methylpropoxy)-2,2,6,6-tetramethyl-4-acetamidopiperidinium) diethylenetriaminepentamethylenephosphonate; and,
(v) Tripotassium bis(1-(2-hydroxy-2-methylpropoxy)-2,2,6,6-tetramethyl-4-oxopiperidinium) diethylenetriaminepentamethylenephosphonate.

10. An ink-jet system according to claim 9 wherein the compound of formula (I) is selected from the group consisting of
(a) Monosodium 1-methoxy-2,2,6,6-tetramethyl-4-acetoxypiperidinium citrate;
(b) Monopotassium 1-methoxy-2,2,6,6-tetramethyl-4-acetamidopiperidinium phosphate;
(c) Monoammonium 1-butoxy-2,2,6,6-tetramethyl-4-acetamidopiperidinium sulfate;
(d) Mono-(N,N,N-triethylammonium) 1-phenoxy-2,2,6,6-tetramethyl-4-methoxy-piperidinium tartrate;
(e) Mono-[N,N-di-n-butyl ammonium]1-ethoxy-2,2,6,6-tetramethyl-4-acetoxypiperidinium maleate;
(f) Mono-[N,N,N-(2-hydroxyethyl)ammonium]1-methoxy-2,2,6,6-tetramethyl-4-propoxypiperidinium oxalate;
(g) Monosodium 1-methoxy-2,2,6,6-tetramethyl-4-(2-hydroxy-4-oxapentoxy)piperidinium carbonate;
(h) Dipotassium 1-(2-hydroxy-2-methylpropoxy)-2,2,6,6-tetramethyl-4-hydroxypiperidinium citrate;
(i) Monosodium bis(1-(2-hydroxy-2-methylpropoxy)-2,2,6,6-tetramethyl-4-hydroxypiperidinium) citrate;
(j) Diammonium (1-(2-hydroxy-2-methylpropoxy)-2,2,6,6-tetramethyl-4-hydroxypiperidinium) citrate;
(k) Monopotassium monosodium bis(1-(2-hydroxy-2-methylpropoxy)-2,2,6,6-tetramethyl-4-hydroxypiperidinium)ethylenediaminetetraacetate;
(l) Monosodium tris(1-(2-hydroxy-2-methylpropoxy)-2,2,6,6-tetramethyl-4-acetamidopiperidinium)ethylenediaminetetraacetate;
(m) Monocalcium bis(1-(2-hydroxy-2-methylpropoxy)-2,2,6,6-tetramethyl-4-oxopiperidinium) ethylenediaminetetraacetate;
(n) Monoammonium tetra(1-(2-hydroxy-2-methylpropoxy)-2,2,6,6-tetramethyl-4-hydroxypiperidinium) diethylenetriaminepentaacetate;
(o) Disodium tris(1-(2-hydroxy-2-methylpropoxy)-2,2,6,6-tetramethyl-4-acetamidopiperidinium) diethylenetriaminepentaacetate;
(p) Tripotassium di(1-(2-hydroxy-2-methylpropoxy)-2,2,6,6-tetramethyl-4-oxopiperidinium) diethylenetriaminepentaacetate;
(q) Di-[N,N-diethylammonium]mono(1-(2-hydroxy-2-methylpropoxy)-2,2,6,6-tetramethyl-4-acetamidopiperidinium)nitrilotriacetate; and,
(r) Diammonium tris(1-(2-hydroxy-2-methylpropoxy)-2,2,6,6-tetramethyl-4-hydroxypiperidinium) diethylenetriaminepentamethylenephosphonate.

11. An ink-jet ink according to claim 3 containing about 0.01 to about 30% by weight of at least one compound of formula (I), based on the weight of the entire ink.

12. An ink-jet ink according to claim 11 containing about 0.1 to about 20%, by weight of at least one compound of formula (I), based on the weight of the entire ink.

13. An ink-jet recording material according to claim 2 containing about 1 to about 10000 mg/m² of at least one compound of the formula (I).

14. An ink-jet recording material according to claim 13 containing about 50 to about 2000 mg/m² of at least one compound of the formula (I).

15. A compound of formula (I) 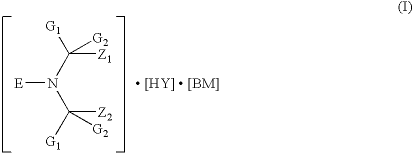
wherein
G₁ and G₂ are independently alkyl of 1 to 4 carbon atoms or are together pentamethylene; Z₁ and Z₂ are each methyl, or Z₁ and Z₂ together form an unsubstituted linking moiety or a linking moiety substituted by one or more groups selected from an ester, ether, hydroxy, oxo, cyanohydrin, amide, amino, carboxy or an urethane group;
E is alkoxy of 1 to 18 carbon atoms, cycloalkoxy of 5 to 12 carbon atoms or aralkoxy of 7 to 15 carbon atoms, or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
HY is an inorganic or organic acid; and, wherein the total charge of cations is equal to the total charge of anions; and
BM is a basic material selected from the group consisting of alkali metal hydroxides, alkaline earth metal hydroxides, and amines.

16. A compound according to claim 15 wherein the compounds of formula (I) are selected from the group consisting of formulae (A*) to (EE*) and (III) to (IIIc) 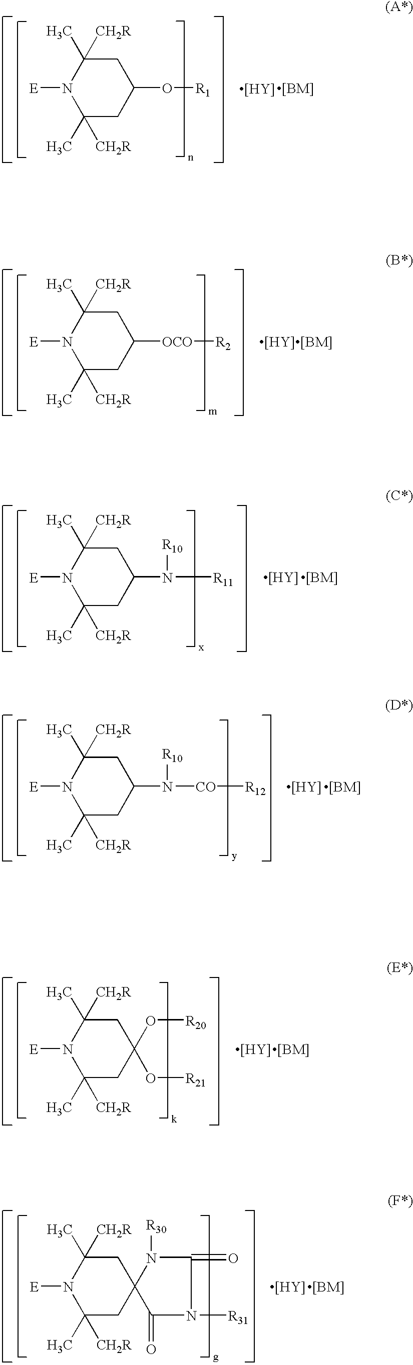 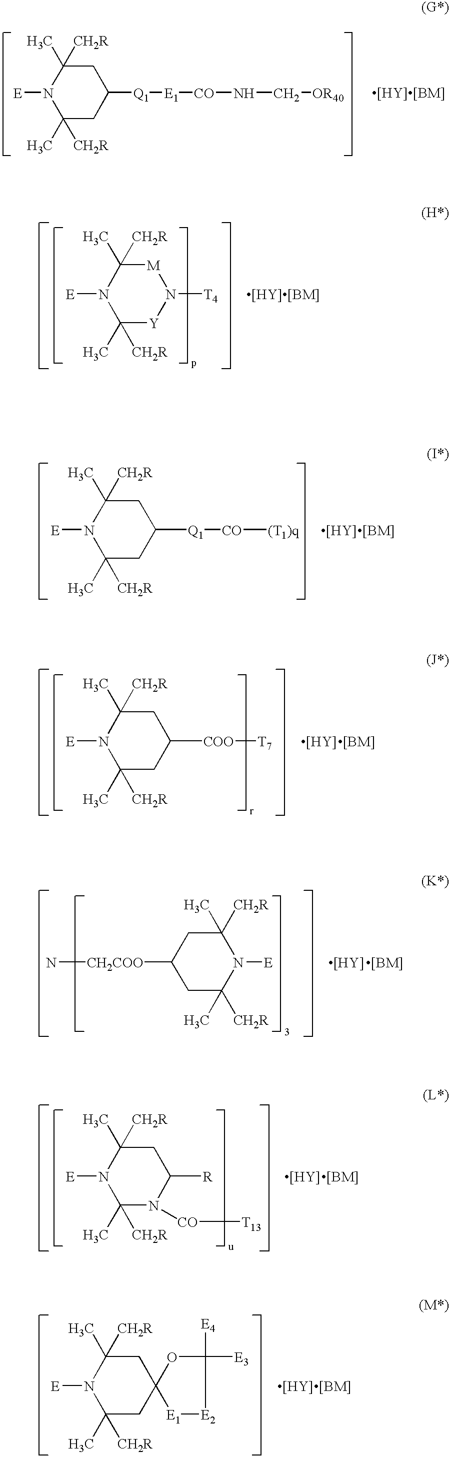 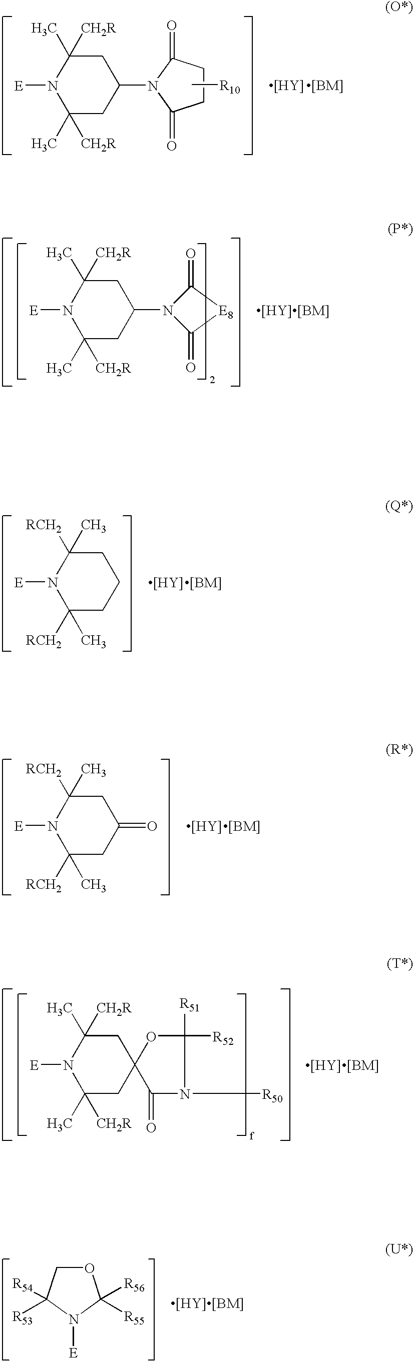 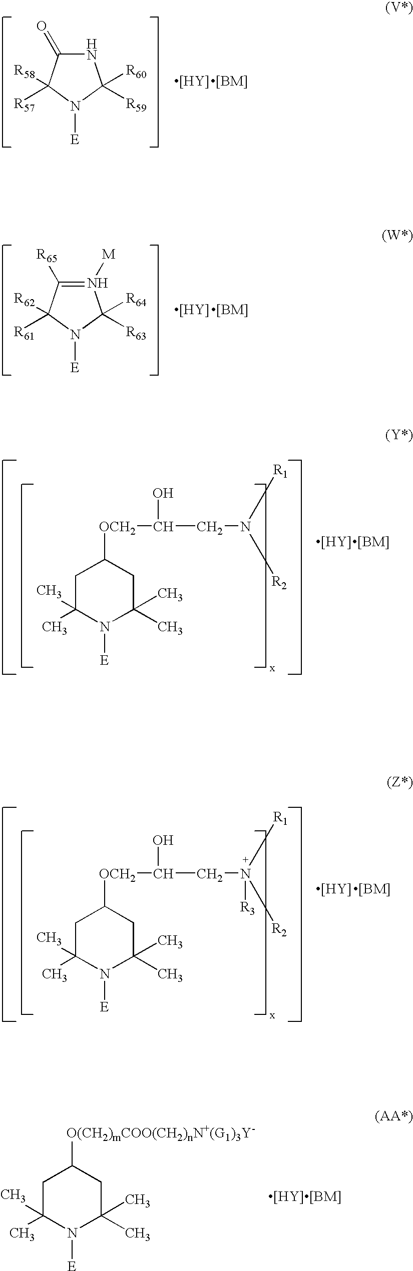 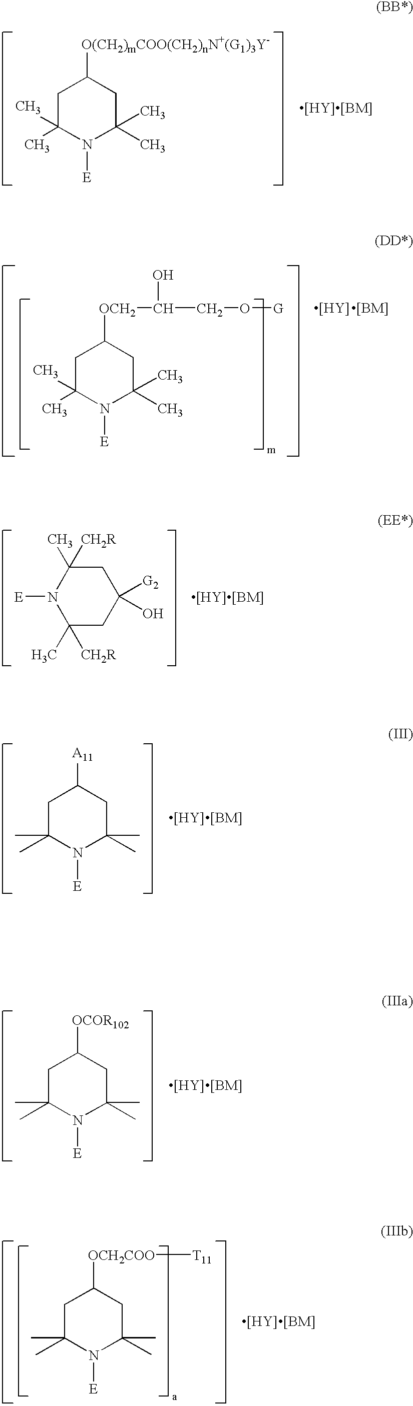 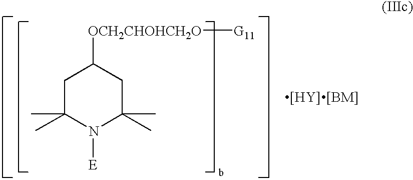
wherein
E is alkoxy of 1 to 18 carbon atoms, cycloalkoxy of 5 to 12 carbon atoms or aralkoxy of 7 to 15 carbon atoms, or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen or methyl; and
in formula (A*) n is 1 or 2,
when n is 1,
R₁ is hydrogen, alkyl of 1 to 18 carbon atoms, alkenyl of 2-18 carbon atoms, propargyl, glycidyl, alkyl of 2 to 50 carbon atoms interrupted by one to twenty oxygen atoms, said alkyl substituted by one to ten hydroxyl groups or both interrupted by said oxygen atoms and substituted by said hydroxyl groups, or
R₁ is alkyl of 1 to 4 carbon atoms substituted by a carboxy group or by —COOZ where Z is hydrogen, alkyl of 1 to 4 carbon atoms or phenyl, or where Z is said alkyl substituted by —(COO⁻)ₙ Mⁿ⁺ where n is 1-3 and M is a metal ion from the 1st, 2nd or 3rd group of the periodic table or is Zn, Cu, Ni or Co, or M is a group Nⁿ⁺(R₂)₄ where R₂ is alkyl of 1 to 8 carbon atoms or benzyl,
when n is 2,
R₁ is alkylene of 1 to 12 carbon atoms, alkenylene of 4 to 12 carbon atoms, xylylene or alkylene of 1 to 50 carbon atoms interrupted by one to twenty oxygen atoms, substituted by one to ten hydroxyl groups or both interrupted by said oxygen atoms and substituted by said hydroxyl groups;
in formula (B*), m is 1 to 4, and
when m is 1,
R₂ is alkyl of 1 to 18 carbon atoms, alkyl of 3 to 18 carbon atoms interrupted by —COO—, alkyl of 3 to 18 carbon atoms substituted by COOH or COO—, or R₂ is —CH₂(OCH₂CH₂)ₙOCH₃
where n is 1 to 12, or
R₂ is cycloalkyl of 5 to 12 carbon atoms, aryl of 6 to 12 carbon atoms, or said aryl substituted by one to four alkyl groups of 1 to 4 carbon atoms, or
R₂ is —NHR₃ where R₃ is alkyl of 1 to 18 carbon atoms, cycloalkyl of 5 to 12 carbon atoms, aryl of 6 to 12 carbon atoms, or said aryl substituted by one to four alkyl of 1 to 4 carbon atoms, or
R₂ is —N(R₃)₂ where R₃ is as defined above,
when m is 2,
R₂ is alkylene of 1 to 12 carbon atoms, alkenylene of 4 to 12 carbon atoms, xylylene, alkylene of 2 to 12 carbon atoms interrupted by —COO—, alkylene of 3 to 18 carbon atoms substituted by COOH or COO—, or R₂ is —CH₂(OCH₂CH₂)ₙOCH₂— where n is 1 to 12, or
R₂ is cycloalkylene of 5 to 12 carbon atoms, aralkylene of 7 to 15 carbon atoms or arylene of 6 to 12 carbon atoms, or
R₂ is —NHR₄NH— where R₄ is alkylene of 2 to 18 carbon atoms, cycloalkylene of 5 to 12 carbon atoms, aralkylene of 8 to 15 carbon atoms or arylene of 6 to 12 carbon atoms, or
R₂ is —N(R₃)R₄N(R₃)— where R₃ and R₄ are as defined above, or
R₂ is —CO—, —NH—CO—NH—, or —N(R3)-CO—N(R3)-,
when m is 3,
R₂ is alkanetriyl of 3 to 8 carbon atoms or benzenetriyl, or
when m is 4,
R₂ is alkanetetrayl of 5 to 8 carbon atoms or benzenetetrayl,
in formula (C*),
R₁₀ is hydrogen, alkyl of 1 to 18 carbon atoms, cycloalkyl of 5 to 12 carbon atoms, aralkyl of 7 to 15 carbon atoms, alkanoyl of 2 to 18 carbon atoms, alkenoyl of 3 to 5 carbon atoms or benzoyl,
x is 1 or 2, and
when x is 1,
R₁₁ is hydrogen, alkyl of 1 to 18 carbon atoms, alkenyl of 2 to 18 carbon atoms, propargyl, glycidyl, alkyl of 2 to 50 carbon atoms interrupted by one to twenty oxygen atoms, said alkyl substituted by one to ten hydroxyl groups or both interrupted by said oxygen atoms and substituted by said hydroxyl groups, or
R₁₁ is alkyl of 1 to 4 carbon atoms substituted by a carboxy group or by —COOZ where Z is hydrogen, alkyl of 1 to 4 carbon atoms or phenyl, or where Z is said alkyl substituted by —(COO⁻)ₙ Mⁿ⁺ where n is 1-3 and M is a metal ion from the 1st, 2nd or 3rd group of the periodic table or is Zn, Cu, Ni or Co, or M is a group Nⁿ⁺(R₂)₄ where R₂ is hydrogen, alkyl of 1 to 8 carbon atoms or benzyl, or
when x is 2,
R₁₁ is alkylene of 1 to 12 carbon atoms, alkenylene of 4 to 12 carbon atoms, xylylene or alkylene of 1 to 50 carbon atoms interrupted by one to twenty oxygen atoms, substituted by one to ten hydroxyl groups or both interrupted by said oxygen atoms and substituted by said hydroxyl groups,
in formula (D*), y is 1 to 4,
R₁₀ is as defined above,
and R₁₂ is defined as R₂ above,
in formula (E*), k is 1 or 2,
when k is 1,
R₂₀ and R₂₁, are independently alkyl of 1 to 12 carbon atoms, alkenyl of 2 to 12 carbon atoms or aralkyl of 7 to 15 carbon atoms, or R₂₀ is also hydrogen, or
R₂₀ and R₂₁ together are alkylene of 2 to 8 carbon atoms or said alkylene substituted by hydroxyl, or are acyloxy-alkylene of 4 to 22 carbon atoms, or
when k is 2,
R₂₀ and R₂₁ are together (—CH₂)₂C(CH₂—)₂,
in formula (F*),
R₃₀ is hydrogen, alkyl of 1 to 18 carbon atoms, benzyl, glycidyl, or alkoxyalkyl of 2 to 6 carbon atoms,
g is 1 or 2,
when g is 1, R₃₁ is defined as R₁ above when n is 1,
when g is 2, R₃₁ is defined as R₁ above when n is 2,
in formula (G*),
Q, is —NR₄₁— or —O—,
E₁ is alkylene of 1 to 3 carbon atoms, or E₁ is —CH₂—CH(R₄₂)—O— where R₄₂ is hydrogen, methyl or phenyl, or E₁ is —(CH₂)₃—NH— or E₁ is a direct bond,
R₄₀ is hydrogen or alkyl of 1 to 18 carbon atoms,
R₄₁ is hydrogen, alkyl of 1 to 18 carbon atoms, cycloalkyl of 5 to 12 carbon atoms, aralkyl of 7 to 15 carbon atoms, aryl of 6 to 10 carbon atoms, or R₄, is —CH₂—CH(R₄₂)—OH where R₄₂ is as defined above,
in formula (H*), p is 1 or 2,
T₄ is as defined for R₁₁ when x is 1 or 2,
M and Y are independently methylene or carbonyl, preferably M is methylene and Y is carbonyl,
in formula (I*),
this formula denotes a recurring structural unit of a polymer where T₁ is ethylene or 1,2-propylene or is the repeating structural unit derived from an alpha-olefin copolymer with an alkyl acrylate or methacrylate, and where
q is 2 to 100,
Q₁ is —N(R₄₁)— or —O— where R₄, is as defined above,
in formula (J*),
r is 1 or 2,
T₇ is as defined for R₁ when n is 1 or 2 in formula (A*),
preferably T₇ is octamethylene when r is 2,
in formula (L*), u is 1 or 2,
T₁₃ is as defined for R₁ when n is 1 or 2 in formula (A*), with the proviso that T₁₃ is not hydrogen when u is 1, in formula (M*),
E₁ and E₂, being different, each are —CO— or —N(E₅)- where E₅ is hydrogen, alkyl of 1 to 12 carbon atoms or alkoxycarbonylalkyl of 4 to 22 carbon atoms, preferably E₁ is —CO— and E₂ is —N(E₅)-,
E₃ is hydrogen, alkyl of 1 to 30 carbon atoms, phenyl, naphthyl, said phenyl or said naphthyl substituted by chlorine or by alkyl of 1 to 4 carbon atoms, or phenylalkyl of 7 to 12 carbon atoms, or said phenylalkyl substituted by alkyl of 1 to 4 carbon atoms,
E₄ is hydrogen, alkyl of 1 to 30 carbon atoms, phenyl, naphthyl or phenylalkyl of 7 to 12 carbon atoms, or
E₃ and E₄ together are polymethylene of 4 to 17 carbon atoms, or said polymethylene substituted by one to four alkyl of 1 to 4 carbon atoms, preferably methyl,
in formula (O*),
R₁₀ is as defined for R₁₀ in formula (C*),
in formula (P*),
E₆ is an aliphatic or aromatic tetravalent radical, preferably neopentanetetrayl or benzenetetrayl,
in formula (T*),
R₅₁ is hydrogen, alkyl of 1 to 18 carbon atoms, cycloalkyl of 5 to 12 carbon atoms, or aryl of 6 to 10 carbon atoms,
R₅₂ is hydrogen or alkyl of 1 to 18 carbon atoms, or
R₅₁ and R₅₂ together of alkylene of 4 to 8 carbon atoms,
f is 1 or 2,
when f is 1,
R₅₀ is as defined for R₁₁ in formula (C*) when x is 1, or R₅₀ is —(CH₂)_{z}COOR₅₄ where z is 1 to 4 and R₅₄ is hydrogen or alkyl of 1 to 18 carbon atoms, or R₅₄ is a metal ion from the 1st, 2nd or 3rd group of the periodic table or a group —N(R₅₅)₄ where R₅₅ is hydrogen, alkyl of 1 to 12 carbon atoms or benzyl,
when f is 2,
R₅₀ is as defined for R₁₁ in formula (C*) when x is 2,
in formula (U*),
R₅₃, R₅₄, R₅₅ and R₅₆ are independently alkyl of 1 to 4 carbon atoms or are together pentamethylene,
in formula (V*),
R₅₇, R₅₈, R₅₉ and R₆₀ are independently alkyl of 1 to 4 carbon atoms or are together pentamethylene,
in formula (W*),
R₆₁, R₆₂, R₆₃ and R₆₄ are independently alkyl of 1 to 4 carbon atoms or are together pentamethylene,
R₆₅ is alkyl of 1 to 5 carbon atoms,
M is hydrogen or oxygen,
wherein in formulas (Y*) to (BB*),
n is 2 to 3,
G₁ is hydrogen, methyl, ethyl, butyl or benzyl,
m is 1 to 4,
x is 1 to 4,
when x is 1, R₁ and R₂ are independently alkyl of 1 to 18 carbon atoms, said alkyl interrupted by one to five oxygen atoms, said alkyl substituted by 1 to 5 hydroxyl groups or said alkyl both interrupted by said oxygen atoms and substituted by said hydroxyl groups; cycloalkyl of 5 to 12 carbon atoms, aralkyl of 7 to 15 carbon atoms, aryl of 6 to 10 carbon atoms or said aryl substituted by one to three alkyl of 1 to 8 carbon atoms, or R₁ is also hydrogen, or R₁ and R₂ are together tetramethylene, pentamethylene, hexamethylene or 3-oxapentamethylene,
when x is 2,
R₁ is hydrogen, alkyl of 1 to 8 carbon atoms, said alkyl interrupted by one or two oxygen atoms, said alkyl substituted by a hydroxyl group, or said alkyl both interrupted by one or two oxygen atoms and substituted by a hydroxyl group,
R₂ is alkylene of 2 to 18 carbon atoms, said alkylene interrupted by one to five oxygen atoms, said alkylene substituted by 1 to 5 hydroxyl groups or said alkylene both interrupted by said oxygen atoms and substituted by said hydroxyl groups; o-, m- or p-phenylene or said phenylene substituted by one or two alkyl of 1 to 4 carbon atoms, or
R₂ is —(CH₂)ₖO[(CH₂)ₖO]ₕ(CH₂)ₖ— where k is 2 to 4 and h is 1 to 40, or
R₁ and R₂ together with the two N atoms to which they are attached are piperazin-1,4-diyl,
when x is 3,
R₁ is hydrogen,
R₂ is alkylene of 4 to 8 carbon atoms interrupted by one nitrogen atom,
when x is 4,
R₁ is hydrogen,
R₂ is alkylene of 6 to 12 carbon atoms interrupted by two nitrogen atoms,
R₃ is hydrogen, alkyl of 1 to 8 carbon atoms, said alkyl interrupted by one or two oxygen atoms, said alkyl substituted by a hydroxyl group, or both interrupted by one or two oxygen atoms and substituted by a hydroxyl group,
p is 2 or 3,
in formula (DD*),
m is 2 or 3,
when m is 2,
G is —(CH₂CHR—O)ᵣCH₂CHR—, where r is 0 to 3, and R is hydrogen or methyl, and
when m is 3, G is glyceryl,
in formula (EE*),
G₂ is —CN, —CONH₂ or —COOG₃ where G₃ is hydrogen, alkyl of 1 to 18 carbon atoms or phenyl,
in formulae (III) to (IIIc)
A11 is OR₁₀₁ or NR₁₁₁R₁₁₂
R₁₀₁ is alkenyl of 2 to 4 carbon atoms, propargyl, glycidyl, alkyl of 2 to 6 carbon atoms interrupted by one or two oxygen atoms, substituted by one to three hydroxyl groups or both interrupted by said oxygen atoms and substituted by said hydroxyl groups, or R₁₀₁ is alkyl of 1 to 4 carbon atoms substituted by carboxy or by the alkali metal, ammonium or C₁-C₄alkylammonium salts thereof; or R₁₀₁ is alkyl substituted by COOE₁₀ where E₁₀ is methyl or ethyl,
R₁₀₂ is alkyl of 3 to 5 carbon atoms interrupted by —COO— or by —CO—, or R₁₀₂ is —CH₂(OCH₂CH₂)_{c}COCH₃ where c is 1 to 4; or
R₁₀₂ is —NHR₁₀₃ where R₁₀₃ is alkyl of 1 to 4 carbon atoms, a is 2 to 4,
when a is 2,
T₁₁ is —(CH₂CHR₁₀₀—O)_{d}CH₂CHR₁₀₀—, where d is 0 or 1, and R₁₀₀ is hydrogen or methyl,
when a is 3, T₁₁ is glyceryl,
when a is 4, T₁₁ is neopentanetetrayl,
b is 2 or 3,
when b is 2,
G₁₁ is —(CH₂CHR₁₀₀—O)_{d}CH₂CHR₁₀₀—, where d is 0 or 1, and R₁₀₀ is hydrogen or methyl, and
when b is 3, G₁₁ is glyceryl;
R₁₁₁ is hydrogen, unsubstituted alkyl of 1 to 4 carbon atoms, alkyl of 1 to 4 carbon atoms substituted by one or two hydroxyl, alkyl of 1 to 4 carbon atoms interrupted by one or two oxygen atoms, or both substituted by one hydroxyl and interrupted by one or two oxygen atoms,
R₁₁₂ is —CO—R₁₁₃ where R₁₁₃ has the same meaning as R₁₁₁, or R₁₁₃ is NHR₁₁₄, wherein R₁₁₄ is unsubstituted alkyl of 1 to 4 carbon atoms, alkyl of 1 to 4 carbon atoms substituted by one or two hydroxyl, alkyl of 1 to 4 carbon atoms substituted by alkoxy of 1 to 2 carbon atoms, or both substituted by one hydroxyl and by alkoxy of 1 to 2 carbon atoms, or R₁₁₁ and R₁₁₂ together are —CO—CH₂CH₂—CO—, or (CH₂)₆CO—;
BM is a basic material selected from the group consisting of alkali metal hydroxides, alkaline earth metal hydroxides, and amines;
amines are R₁₁₅—N(R₁₁₆)—R₁₁₇, wherein
R₁₁₅, R₁₁₆, and R₁₁₇ are independently hydrogen, straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or said alkyl substituted by one or more —OH, —OCO—R₁₁₈, —OR₁₁₉, or —NH₂ groups or mixtures thereof; or said alkyl or said alkenyl interrupted by one or more —O—, —NH— or —NR₁₁₉— groups or mixtures thereof and which can be unsubstituted or substituted by one or more —OH, —OR₁₁₉ or —NH₂ groups or mixtures thereof;
R₁₁₈ is hydrogen, straight or branched chain C₁-C₁₈alkyl, C₅-C₁₂cycloalkyl, straight or branched chain C₃-C₈alkenyl, C₆-C₁₄aryl or C₇-C₁₅aralkyl,
R₁₁₉ is straight or branched chain alkyl of 1 to 18 carbon atoms;
alkali metal hydroxide is sodium hydroxide, potassium hydroxide, or rubidium hydroxide;
alkaline earth metal hydroxide is magnesium hydroxide, calcium hydroxide, strontium hydroxide, or barium hydroxide;
HY is an inorganic or organic acid; wherein the total charge of cations is equal to the total charge of anions; and
Y is phosphate, phosphonate, carbonate, bicarbonate, nitrate, chloride, bromide, bisulfite, sulfite, bisulfate, sulfate, borate, formate, acetate, benzoate, citrate, oxalate, tartrate, acrylate, polyacrylate, fumarate, maleate, itaconate, glycolate, gluconate, malate, mandelate, tiglate, ascorbate, polymethacrylate, a carboxylate of nitrilotriacetic acid, a carboxlylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

17. A compound according to claim 16 wherein the compounds of formula (I) are selected from the group consisting of (A*), (B*), (C*), (D*), (Q*), (R*), (Y*), and (Z*),
wherein
E is alkoxy of 1 to 10 carbon atoms, cycloalkoxy of 5 to 8 carbon atoms or aralkoxy of 7 to 12 carbon atoms, or E is —O-T-(OH)_{b},
T is a straight or branched chain alkylene of 1 to 10 carbon atoms, cycloalkylene of 5 to 10 carbon atoms, cycloalkenylene of 5 to 10 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen;
in formula (A*), n is 1 or 2,
when n is 1,
R₁ is hydrogen, alkyl of 1 to 6 carbon atoms, alkenyl of 2-6 carbon atoms, propargyl, glycidyl, alkyl of 2 to 20 carbon atoms interrupted by one to ten oxygen atoms, said alkyl substituted by one to five hydroxyl groups or both interrupted by said oxygen atoms and substituted by said hydroxyl groups, or
R₁ is alkyl of 1 to 4 carbon atoms substituted by a carboxy group or by —COOZ where Z is hydrogen or alkyl of 1 to 4 carbon atoms,
when n is 2,
R₁ is alkylene of 1 to 8 carbon atoms, alkenylene of 4 to 8 carbon atoms, alkylene of 1 to 20 carbon atoms interrupted by one to ten oxygen atoms, substituted by one to five hydroxyl groups or both interrupted by said oxygen atoms and substituted by said hydroxyl groups,
in formula (B*), m is 1 or 2
when m is 1,
R₂ is alkyl of 1 to 4 carbon atoms or R₂ is CH₂(OCH₂CH₂)ₙOCH₃ where n is 1 to 12, or
R₂ is phenyl, or said phenyl substituted by one to three methyl groups, or
R₂ is —NHR₃ where R₃ is alkyl of 1 to 4 carbon atoms or phenyl, or said phenyl substituted by one or two methyl groups,
when m is 2,
R₂ is alkylene of 1 to 8 carbon atoms, alkenylene of 4 to 8 carbon atoms, or R₂ is —CH₂(OCH₂CH₂)ₙOCH₂— where n is 1 to 12, or
R₂ is —NHR₄NH— where R₄ is of 2 to 6 carbon atoms, aralkylene of 8 to 15 carbon atoms or arylene of 6 to 12 carbon atoms, or
R₂ is —CO— or —NHCONH—,
in formula (C*),
R₁₀ is hydrogen or, alkanoyl of 1 to 3 carbon atoms,
x is 1 or 2,
when x is 1,
R₁₁ is hydrogen, alkyl of 1 to 6 carbon atoms or glycidyl, or
R₁₁ is alkyl of 1 to 4 carbon atoms substituted by a carboxy group or by COOZ where Z is hydrogen or alkyl of 1 to 4 carbon atoms,
when x is 2,
R₁₁ is alkylene of 1 to 6 carbon atoms,
in formula (D*),
R₁₀ is hydrogen,
y is 1 or 2,
R₁₂ is defined as R₂ above,
in formula (Y*) and (Z*),
x is 1 or 2,
when x is 1,
R₁ and R₂ are independently alkyl of 1 to 4 carbon atoms or R₁ and R₂ are together tetramethylene, or pentamethylene,
R₂ is hydrogen or alkyl of 1 to 4 carbon atoms, said alkyl group substituted by a hydroxyl group,
when x is 2,
R₁ is hydrogen, alkyl of 1 to 4 carbon atoms, said alkyl substituted by a hydroxyl group,
R₂ is alkylene of 2 to 6 carbon atoms,
R₃ is as defined above,
BM is a basic material selected from the group consisting of alkali metal hydroxides, alkaline earth metal hydroxides, and amines;
amines are R₁₁₅—N(R₁₁₆)—R₁₁₇, wherein
R₁₁₅, R₁₁₆, and R₁₁₇ are independently hydrogen, straight or branched alkyl chain of 1 to 18 carbon atoms, straight or branched chain alkenyl of 2 to 12 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or said alkyl substituted by one or more —OH, —OR₁₁₉, or —NH₂ groups or mixtures thereof; or said alkyl or said alkenyl interrupted by one or more —O—, —NH— or —NR₁₁₉— groups or mixtures thereof and which can be unsubstituted or substituted by one or more —OH, —OR₁₁₉ or —NH₂ groups or mixtures thereof;
alkali metal hydroxide is sodium hydroxide or potassium hydroxide;
alkaline earth metal hydroxide is magnesium hydroxide and calcium hydroxide;
HY is an inorganic or organic acid; and, wherein the total charge of cations is equal to the total charge of anions; and
Y is phosphate, phosphonate, carbonate, bicarbonate, chloride, bromide, bisulfate, sulfate, borate, formate, acetate, benzoate, citrate, oxalate, tartrate, acrylate, fumarate, maleate, itaconate, glycolate, gluconate, malate, mandelate, tiglate, ascorbate, a carboxylate of nitrilotriacetic acid, a carboxylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

18. A compound according to claim 17 wherein the compounds of formula (I) are selected from the group consisting of (A*), (B*), (C*), (D*), (Q*), and (R*),
wherein
E is alkoxy of 1 to 10 carbon atoms, cycloalkoxy of 5 to 8 carbon atoms or aralkoxy of 7 to 12 carbon atoms, or E is —O-T-(OH)_{b},
T is a straight or branched chain alkylene of 1 to 10 carbon atoms, cycloalkylene of 5 to 10 carbon atoms, cycloalkenylene of 5 to 10 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen, in formula (A*),
h is 1,
R₁ is hydrogen, alkyl of 1 to 4 carbon atoms, glycidyl, alkyl of 2 to 4 carbon atoms interrupted by one or two oxygen atoms, said alkyl substituted by one or two hydroxyl groups or both interrupted by said oxygen atoms and substituted by said hydroxyl groups, or
R₁ is alkyl of 1 to 4 carbon atoms substituted by —COOZ where Z is hydrogen or alkyl of 1 to 4 carbon atoms,
in formula (B*),
m is 1 or 2,
R₂ is alkyl of 1 to 4 carbon atoms or R₂ is CH₂(OCH₂CH₂)ₙOCH₃ where n is 1 to 4,
when m is 2,
R₂ is alkylene of 1 to 8 carbon atoms,
in formula (C*),
R₁₀ is hydrogen or alkanoyl of 1 or 2 carbon atoms,
x is 1 or 2,
when x is 1,
R₁₁ is hydrogen, alkyl of 1 to 4 carbon atoms or glycidyl,
R₁₁ is alkyl of 1 to 4 carbon atoms substituted by COOZ where Z is hydrogen or alkyl of 1 to 4 carbon atoms,
when x is 2,
R₁₁ is alkylene of 1 to 6 carbon atoms,
in formula (D*),
R₁₀ is hydrogen,
y is 1 or 2,
R₁₂ is defined as R₂ above;
BM is a basic material selected from the group consisting of alkali metal hydroxides, alkaline earth metal hydroxides, and amines;
amines are R₁₁₅—N(R₁₁₆)—R₁₁₇, wherein
R₁₁₅, R₁₁₆, and R₁₁₇ are independently hydrogen, straight or branched alkyl chain of 1 to 12 carbon atoms, or said alkyl substituted by one or more —OH, —OR₁₁₉, or —NH₂ groups or mixtures thereof; or said alkyl interrupted by one or more —O—, —NH— or —NR₁₁₉— groups or mixtures thereof and which can be unsubstituted or substituted by one or more —OH, —OR₁₁₉ or —NH₂ groups or mixtures thereof;
R₁₁₉ is straight or branched chain alkyl of 1 to 8 carbon atoms;
alkali metal hydroxide is sodium hydroxide or potassium hydroxide;
alkaline earth metal hydroxide is calcium hydroxide;
HY is an inorganic or organic acid; and, wherein the total charge of cations is equal to the total charge of anions; and
Y is phosphate, phosphonate, carbonate, bicarbonate, chloride, bromide, bisulfate, sulfate, borate, formate, acetate, benzoate, citrate, oxalate, tartrate, ascorbate, acrylate, fumarate, maleate, itaconate, glycolate, gluconate, malate, mandelate, tiglate, a carboxylate of nitrilotriacetic acid, a carboxylate of hydroxyethylethylenediaminetriacetic acid, a carboxylate of ethylenediaminetetraacetic acid, a carboxylate of diethylenetriaminepentaacetic acid, a carboxylate of diethylenediaminetetraacetic acid, a carboxylate of diethylenetriaminepentaacetic acid, alkylsulfonate, arylsulfonate, or alkyl-substituted arylsulfonate.

19. A compound according to claim 18 wherein the compound of formula (I) is selected from the group consisting of
(a) Monosodium 1-methoxy-2,2,6,6-tetramethyl-4-acetoxypiperidinium citrate;
(b) Monopotassium 1-methoxy-2,2,6,6-tetramethyl-4-acetamidopiperidinium phosphate;
(c) Monoammonium 1-butoxy-2,2,6,6-tetramethyl-4-acetamidopiperidinium sulfate;
(d) Mono-(N,N,N-triethylammonium) 1-phenoxy-2,2,6,6-tetramethyl-4-methoxy-piperidinium tartrate;
(e) Mono-[N,N-di-n-butyl ammonium]1-ethoxy-2,2,6,6-tetramethyl-4-acetoxypiperidinium maleate;
(f) Mono-[N,N,N-(2-hydroxyethyl)ammonium]1-methoxy-2,2,6,6-tetramethyl-4-propoxypiperidinium oxalate;
(g) Monosodium 1-methoxy-2,2,6,6-tetramethyl-4-(2-hydroxy-4-oxapentoxy)piperidinium carbonate;
(h) Dipotassium 1-(2-hydroxy-2-methylpropoxy)-2,2,6,6-tetramethyl-4-hydroxypiperidinium citrate;
(i) Monosodium bis(1-(2-hydroxy-2-methylpropoxy)-2,2,6,6-tetramethyl-4-hydroxypiperidinium) citrate;
(j) Diammonium (1-(2-hydroxy-2-methylpropoxy)-2,2,6,6-tetramethyl-4-hydroxypiperidinium) citrate;
(k) Monopotassium monosodium bis(1-(2-hydroxy-2-methylpropoxy)-2,2,6,6-tetramethyl-4-hydroxypiperidinium)ethylenediaminetetraacetate;
(l) Monosodium tris(1-(2-hydroxy-2-methylpropoxy)-2,2,6,6-tetramethyl-4-acetamidopiperidinium)ethylenediaminetetraacetate;
(m) Monocalcium bis(1-(2-hydroxy-2-methylpropoxy)-2,2,6,6-tetramethyl-4-oxopiperidinium) ethylenediaminetetraacetate;
(n) Monoammonium tetra(1-(2-hydroxy-2-methylpropoxy)-2,2,6,6-tetramethyl-4-hydroxypiperidinium) diethylenetriaminepentaacetate;
(o) Disodium tris(1-(2-hydroxy-2-methylpropoxy)-2,2,6,6-tetramethyl-4-acetamidopiperidinium) diethylenetriaminepentaacetate;
(p) Tripotassium di(1-(2-hydroxy-2-methylpropoxy)-2,2,6,6-tetramethyl-4-oxopiperidinium) diethylenetriaminepentaacetate;
(q) Monobenzylammonium bis(1-(2-hydroxy-2-methylpropoxy)-2,2,6,6-tetramethyl-4-hydroxypiperidinium)nitrilotriacetate;
(r) Di-[N,N-diethylammonium]mono(1-(2-hydroxy-2-methylpropoxy)-2,2,6,6-tetramethyl-4-acetamidopiperidinium)nitrilotriacetate;
(s) Monosodium bis(1-(2-hydroxy-2-methylpropoxy)-2,2,6,6-tetramethyl-4-oxopiperidinium) nitrilotriacetate;
(t) Diammonium tris(1-(2-hydroxy-2-methylpropoxy)-2,2,6,6-tetramethyl-4-hydroxypiperidinium) diethylenetriaminepentamethylenephosphonate;
(u) Monosodium tetra(1-(2-hydroxy-2-methylpropoxy)-2,2,6,6-tetramethyl-4-acetamidopiperidinium) diethylenetriaminepentamethylenephosphonate; and,
(v) Tripotassium bis(1-(2-hydroxy-2-methylpropoxy)-2,2,6,6-tetramethyl-4-oxopiperidinium) diethylenetriaminepentamethylenephosphonate.

20. A method for stabilising inkjet prints, which comprises applying to a recording material for ink-jet printing an ink composition containing a water soluble dye or a solution of a dye in an organic solvent and at least one compound of the formula (I) as defined in claim 1 and drying said recording material.

21. A method for stabilising inkjet prints, which comprises applying to a recording material for ink-jet printing a casting or coating dispersion or an aqueous or organic solution containing at least one compound of the formula (I) as defined in claim 1 and further applying either an ink composition containing a water soluble dye or a solution of a dye in an organic solvent; or an ink composition containing a water soluble dye or a solution of a dye in an organic solvent and at least one compound of the formula (I) and drying said recording material.
